(19) United States
(12) Patent Application Publication
(10) Pub. No.: US 2020/0258014 A1
(43) Pub. Date: Aug. 13, 2020

(54) PRIORITIZATION PROCESS

(71) Applicant: Richard Graf, Koenigstein im Taunus (DE)

(72) Inventor: Richard Graf, Koenigstein im Taunus (DE)

(21) Appl. No.: 16/269,932

(22) Filed: Feb. 7, 2019

(51) Int. Cl. G06Q 10/06; G06Q 10/10

(52) U.S. Cl. CPC G06Q 10/0637; G06Q 10/0633; G06Q 10/103; G06Q 10/06313; G06Q 10/06316

(57) ABSTRACT

The invention relates to a prioritization process for achieving a commonly agreed ranking of a plurality of topics handleable with resources available, the process comprises the following steps of deciding whether a common understanding of a specific topic exists; evaluating that specific topic according to its urgency and importance using only one priority indicator; committing on a commonly shared prioritization, expressed as the priority indicator of that specific topic; and ranking of the plurality of topics based on the committed commonly shared prioritization of each specific topic.

### TECHNICAL FIELD OF THE INVENTION

The invention is in the field of prioritization processes for achieving a commonly agreed ranking of a plurality of topics that can be handled with resources available that is suitable for agile methods or conventional methods. A prioritization software application for leading the prioritization process is also provided herewith.

The invention is further in the field of quality processes for achieving a commonly agreed quality in at least one of the decision management, commitment process and/or prioritization process. The quality is expressed by a quality information that is a 2-tupel information combining a precursor quality indicator and a successor quality indicator. A quality process software application for leading the quality process is also provided herewith.

The invention is further in the field of intuitive processes used in decision-making processes which are applicable to individual decisions as well as team-based decisions. An intuition process software application for leading the quality process is also provided herewith.

The invention is further in the field of resource processes to provide sufficient resource information to obtain a success in the process in which the resource process is required. A resource process software application for leading the resource process is also provided herewith.

The processes described herein are all suitable for agile methods and for traditional methods for a great variety of use cases, e.g. developing software or planning personal as well as business measures.

### BACKGROUND OF THE INVENTION

There are different methods to organize a company, examples are agile methods, cooperative methods or authoritarian methods, each having a different approach in view of participation, hierarchical structure and leadership. In each of these methods, a prioritization of a plurality of topics is required.

Authoritarian methods and cooperative methods are considered as conventional (classic) methods having a strict hierarchical structure, such as missions to be accomplished, strategy to follow this mission, project to fulfil the strategy and tasks to fulfil the projects. Such a structure is considered an overhead producing, slow and inefficient.

In contrast to the classic methods, agile methods may be used in companies to reduce planning structures. The aim of agility is to provide people and companies with the flexibility to act in the dynamic of today's globalized world and to respond to disruptive changes.

Digitization is forcing disruptive changes due to machine-human-machine communication and, above all, machine-machine-communication. Thus, artificial intelligence, which is now gaining serious importance, requires commitment processes, prioritization processes, quality processes, decision-making processes, and resource processes that are automated.

Already known agile working methods, such as SCRUM or KANBAN, lead to a fundamental paradigm shift in a project approach and at the same time force an agile leadership behavior at eye level in flat hierarchies. Both of the contradictory leadership paradigms (traditional authoritarian leadership and agile approaches at eye level) require automated require commitment processes, prioritization processes, quality processes, decision-making processes, and resource processes.

A prioritization process is normally used to answer three core questions of a company by the responsible persons:
(1) What should not be done?
(2) What should be done?
(3) In which order should it be done?

These three core questions are driven by various requirements from different areas compete for limited resources such as time, budget, competence, focus and implementation capacity. With a prioritization process, a jointly supported (=commonly shared) ranking of topics is set within a given timeframe. Such a prioritization decision should be valid without any company department dependency. Such a prioritization decision should be applicable for single persons, for coached persons or for larger teams with or without responsible persons of the departments in the sense of the company as a whole.

In any way, a prioritization process is fundamentally different from a decision-making process. Leadership essentially means prioritizing and subsequently (based thereon) making a decision. This applies to authoritarian, participative leaders as well as to agile teams (acting at eye level). Both, the prioritization process and the decision-making process use the emotion system as well as the cognitive subsystem but are two fundamentally different processes as shortly explained in the following: Intuition (gut feeling), as a result of the emotion system and can only give consent or rejection to a subject. It is not able to make a decision to an alternative or to choose between several options. However, intuition is contained in every decision by the inseparability of emotions, intuition and cognition. Nevertheless, it is only conditionally suitable for conscious decision-making processes on its own. Intuition (gut feeling) are neither suitable for rational decisions nor for prioritizing. Thus, the question of head or gut feeling, which is not meaningful, can still be answered for rational decisions and prioritizations, namely, use first the intuition, then the cognitive subsystem and finalize with the intuition. The advantages of intuition, above all its speed and the retrieval of expert knowledge, should therefore be embedded in all decision-making processes at the appropriate point, including prioritizations and rational decisions.

The above applies to each individual and even more to a team or to teams having a plurality of participants. In addition, teams are required to integrate their complete group competence, also called swarm intelligence. The group competence arises from the ability of the individual participants to bring their competences into a commonly shared (=jointly shared; =commonly agreed) decision. Group competence is released through the use of decision-making processes such as the prioritization process and thus supports group diversity also in prioritization processes.

The object of the present disclosure is to design a prioritization process which efficiently and effectively ranks a plurality of topics in order to answer the three core questions. The prioritization process should be suitable for both, a single individual or a group having a different number of participants. In either case, a prioritization process should guide the process of making a prioritization between individual participants in such a way that no decision-making phenomena also called cognitive biases occurs that may adversely affect any prioritization decision.

The automatable prioritization process and its valuable decision algorithms for machine-human-communication, human-machine-communication and especially machine-machine-communication may be implementable in machines. The computer system aims to foster future prioritization-making culture, bring together traditional (conventional) and agile methods and foster group intelligence.

The results of the above-mentioned decision management, commitment processes and/or prioritization processes should be produced with an appropriate use of (available) resources and with an appropriate quality. The quality of the herein described decision-making, commitment processes, resource processes and/or prioritization processes should already be established in early phases of that processes in order to limit later challenges, problems and expenses.

Quality in a multi-stage process is only as good as its weakest link, because subsequent processes or process steps can rarely compensate for a lack of quality in a previous process or process step. As a consequence, the desired quality is often not achieved. Even if deficiencies in a process chain can be mitigated selectively by greater commitment and partially compensated by shifting competence, frustration is mostly obtained. In long term runs it further leads to direct and/or indirect quality losses.

Quality process is a standard process to achieve appropriate common quality in any process. Both, the adaptation to the respective functional and technical details, are described in a change project. However, often there is no chance to carry out a professional redesign and/or (re-) implementation. In most cases, a given situation has to be accepted and a used process can only be improved on that given basis.

In agile projects, a quality process is often a prerequisite for a successful use and introduction of agile methods. The artefacts sprint and product backlog, which receive an appropriate quality, become of high importance. Without sufficient quality, the potential of agile methods cannot be exhausted.

The increasing complexity of processes, the increasing number of participants and the high-speed efforts to be fulfilled in efficient manner is more and more difficult.

Thus, it is a further object of the present disclosure to design a quality process, in which a personal responsibility of an involved participant in a process is developed as a prerequisite for achieving a common success in one of the above-mentioned decision management, commitment processes and/or prioritization processes. The responsibility for the own process result (success) should be forced and should be taken over. In addition, a common support for an entire delivery result should be developed and anchored in the herein described decision-making processes, commitment processes, resource processes, and/or prioritization processes.

A quality indicator for monitoring and controlling should be automatically generated and should be maintained in a self-regulating quality process to result in a reliability between all process participants, especially in a transitions between different process steps (the transition is hereinafter also referred to as quality gates).

Furthermore, an intuition is a result of two inextricably linked decision-making subsystems; e.g. a cognitive subsystem and an emotional subsystem of a human's brain. The emotional subsystem is not accessible by the human's consciousness. A generated impulse of the emotional subsystem is usually perceived as a “GO” or “DONT-GO” impulse that is subsequently interpreted as consent or rejection. Such a simple impulse is not sufficiently differentiated for a conscious decision to be made.

Less differentiated impulses result from an emotional excitement; or result from differently composed and differently strong emotional feelings; or lead to an extremely individual coherent world view, which consists of uncontrolled access to conscious memory content. These hitherto unexplained effects are the main reasons not use intuition in an entrepreneurial decision in a decision-making process.

So, it is a further objective to enable an intuition to an entrepreneurial decision and to integrate it as an intuition process in a congenial decision-making process or system. An intuitive decision—integrated in every decision-making process should be handled as a safe and conscious decision-making tool (component) that may be used when there is no time for a cognitive supplementation

Parties involved in the above described processes should be under an obligation to make their contribution to a solution. It should not be criticized. Instead, the problem should be highlighted, or the causes should be investigated. Any retrospective view should be avoided. Instead, the competence should be stringently demanded. Discussions should be shortened drastically.

Thus, it is a further objective to trigger a clear resource process, which enables success and in which it quickly becomes apparent, what and how much is necessary for a success in a process or project.

### SUMMARY OF THE INVENTION

The above identified objects are solved by the features of the independent claims.

According to an aspect of the invention, a prioritization process for achieving a commonly agreed ranking of a plurality of topics handleable with resources available, the process comprises the following steps of: Deciding by each participant whether a common understanding of a specific topic exists; Evaluating by each participant that specific topic using one priority indicator represented by a scale of ten different values; Committing on a commonly shared prioritization of that specific topic, expressed by a committed priority indicator; and Ranking of the plurality of topics based on the committed commonly shared prioritization of each specific topic.

The priority indicator (hereinafter also referred to as key indicator of the prioritization process) can be used to define a plurality of different characteristics in fields. The priority indicator may be used for an evaluation of the topic according to its urgency and/or importance, as for instance important in a business or personal measure. Alternatively, or additionally the priority indicator may be used for an evaluation of the topic according to a degree of difference, as for instance important in the advertisement business. Alternatively, or additionally the priority indicator may be used for an evaluation of the topic according to innovation, as for instance important in a research and development area. Alternatively, or additionally the priority indicator may be used for an evaluation of the topic according to knowledge. It is essential for the prioritization process that all characteristics of a topic are combined into this (one) single key indicator. By merging them into a single indicator, you can later change and extend the characteristics. The prioritization processes remain independent and prove to be robust against changes in the topics or characteristics of the topics.

Priority has two different meanings: (1) Picking something from a plurality and (2) giving something priority to put it in order (e.g. a ranking). These two meanings are separated in the inventive prioritization process, especially if several participants are involved in the prioritization process. The separation becomes indispensable if a large number of topics are to be prioritized and even more if arbitrary points for interruptions are required.

The inventive prioritization process hereinafter also deals with both meanings. The ranking of a topic out of a plurality of topics according to preset goals or objectives is the main achievement. The first core questions (What should not be done? What should be done?) are answered after the committing step, since during the priority process, useless topics are excluded or ranked with lowest priority which can be interpreted as above meaning (1). Additionally, the remaining topics are pre-prioritized by the commonly shared prioritization and are further ranked in the ranking step, which answers the third core question (In which order should it be made?) and can be interpreted as above meaning (2).

In the inventive prioritization process, the topics ranking is for instance regulated according to urgency and importance of that topic as the priority indicator. Any evaluation on the priority indicator, such as urgency and importance, is performed intuitively or cognitively or with a decision-making strategy: intuitively-cognitively-intuitively. Once the priority indicator is determined and commonly agreed on, the ranking of the topic is defined. This is very different to known approaches that usually fail. Experienced executives and specialists tend to skip the inventive necessary evaluation without having seen an overview of all topics and to go straight to the order of precedence. Then sentences like “That is more important” or “This topic is alternative-less” come up.

The inventive prioritization process hereinafter also includes an evaluation of each of the plurality of topics according to uniform criteria, with which they are then placed in a clear order (ranking). Prioritization is the process of identifying important topics for any given objective. These topics are then implemented on the basis of available capacities and resources.

The topics to be ranked can be any suitable topic and may be at least one from the following list: a story in a backlog of an agile method, and/or a work package in a classic (traditional, conventional) method, and/or a ticket in a process system, and/or a project in a portfolio management, or a business requirement, and/or a process improvement, and/or measures for strategic corporate development and/or a personal project; and/or a personal time-management.

The evaluation is made on the basis of one single priority indicator. This indicator automatically puts the topics in a pre-ranking (pre-prioritization). A resulting ranking is given by prioritization and deciding.

Valuable decisions are a key requirement for success. Valuable decisions lead to accomplishing external and internal challenges, e.g. when managing a project. Valuable decisions are those decisions that are commonly agreed on, meaning that each individual participant in a decision-making process manufactures the commonly supported decision that has been made and supports the measures that may have been defined therewith.

Valuable decisions are achieved during a commitment process which leads to a commitment given from each individual participant as for instance described in U.S. Ser. No. 16/227,483 filed on Dec. 20, 2018 by the same applicant. This commitment process is also required for this inventive prioritization process.

Due to the inventive prioritization concept, prioritization can now become a reliable standardized process leading to reasonable results in any business or any personal areas. Aligned with given goals, the responsible person(s) can achieve maximum benefit with available resources. The primary effect is a reliable and predictable result, which can be achieved in a single prioritization process that can be verified and generated in a measurable manner. The robustness of that prioritization process prevents influences and manipulations from one individual participant and ensures that each of the plurality of topics is handled commonly. This means a backlogs of an agile method can be processed as planned and any prioritization is returned to standard control methods.

The inventive prioritization process is based on a decision-making process in a human's brain to reduce time required for the prioritization process. Experiences show that the inventive prioritization process is much faster than known approaches, a time reduction by a factor of five to at least twenty can be achieved. The involved responsible persons develop a corporate culture in which safety, esteem and understanding are created jointly by the reliable process. The group competence (swarm competence) is used, and managers sight of view enriches, because knowledge of all participating experts is made available.

The prioritization process involves all participants, and the process forces everyone to provide an opinion and to take a transparent stance. Divergent perspectives are transparent right from the beginning, and, through the participation of all required authorities, they lead to a common constructive solution. The compelling inner logic leads to the goal to be attained and makes the prioritization process a solid, robust tool that copes well with blurring, different and adverse situations. The prioritization process creates a self-organized process that grows a culture of openness, commitment, honesty, security, and shared commitment.

A quick, open assessment of the situation shows the extent to which the prioritization can be achieved. Thus, failure in later phases is unlikely and tactical behavior of one of the participants are clearly identified during the process. This saves time and resources. Protection against failure inherent in reservations and risks is valued and transformed into success factors in a transfer process.

An automatically generated documentation (protocolling of the outcome of different phases and sub-steps in these phases) enables clear and open communication, easy restart points after interruptions, and provides easy tracking and targeted follow-up. The clear and accepted structure allows for an iterative execution through assumptions without full participation and availability of expert knowledge. The compelling inner logic leads to the goal and makes the prioritization process a solid and robust tool that copes well with blurring and different as well as adverse situations. The prioritization process creates a self-organized process that grows without forcing a culture of openness, commitment, honesty, security, and shared commitment.

This prioritization process can be implemented as a software solution, e.g. a cloud-based service. So, an appropriate application should be used or installed and running on a terminal device, e.g. a handheld device, or personal computer. This application automates, guides and protocols each step in the prioritization process. This application may be used to guide a leader in the prioritization process (Master) through the prioritization process. The application itself can be the leader of the prioritization process. This feature is critical for eye level collaboration and especially for cloud services and artificial intelligence when there is no human leader left.

In another aspect of the present disclosure there is provided a quality process. In a first step of a core concept of the quality process, a precursor object (also referred to as a “requirement”) is transferred from a precursor entity (hereinafter “precursor”) to a successor entity (hereinafter “successor”). Precursor and successor are directly following process entities in any kind of process, such as a business process or a project-management. During the object transfer, a precursor quality indicator is self-estimated by the precursor and this precursor quality indicator is provided to the successor together with the precursor object. In a directly following second step, the successor reflects the quality of the precursor object with an own successor quality indicator. Based on both, the precursor quality indicator and the successor quality indicator, a quality information for the transferred precursor object is obtained. This quality information is used to express the quality of the precursor object.

The term “quality” has two intrinsic meanings. Primary it is a degree of desired and intended nature (=the quality) that defines a value of an object (here precursor object and successor object) as for instance represented in quality standard ISO 9000. Secondarily, it is an inner willingness and attitude to do good things for others (=goodness).

The successor quality indicator from the successor is the basis for a self-organized process quality. This successor quality indicator inventively indicates whether a successor object (also referred to as “design”) can be established with a (commonly agreed) good quality based on the merits of the successor (alone).

The precursor quality indicator in combination with a difference between the successor quality indicator and the precursor quality indicator are inventively used for monitoring and controlling the self-learning quality process.

The quality information (and its resulting difference) is used in all follow-up processes. The quality information expresses that a quality can be obtained (solved) in a resource-oriented manner within a dialogue between the successor and the precursor. A successor's responsibility has to be clearly and supportively addressed in a resource process (as also described herein) so that a successor quality indicator can be increased (if necessary). A precursor's responsibility is to establish the quality on its own by using the provided resource information. When choosing a successor quality indicator of a certain value, the successor signals that the quality is good enough to independently establish a subsequent process result (the successor object) with successors means and the quality of the successor object would be independent on the precursor.

Between each of two process entities (such as precursor and successor), one quality gate is placed. For each quality gate, one quality information is derived, preferably expressed by a 2-tupel of two quality indicators having values derived from a K-i-E scale.

Whenever a resource for achieving the quality is questioned or additional resources are demanded, the herein described resource process should be applied. However, it remains the responsibility of precursor and successor to manage the quality establishment. So, the inventive quality process reduces any outside-triggering and shifts an outside organization to a self-responsibility of involved (internal) process participants.

Preferably, in case a strategic development and a technical development are separated and linked to different departments in the company, the precursor entity may represent a technical requirement as for instance defined by a technical development department. A further, entity is defined in the quality process that represents a strategic requirement as for instance defined by a strategic department. Both, technical requirement entity and strategic requirement entity, work together to establish a good quality on the (common) requirements. The technical requirement is this additionally linked to a successor quality indicator of the strategic requirement in order to illustrate whether a rough and unspecific strategic requirement object has sufficient quality to be processed in subsequent processes with sufficient quality.

In case, an estimation in the successor regarding effort or complexity are too high, an inventive re-commitment object in a re-commitment entity can adapt the requirements in order to correct unplanned situations.

The inventive quality process brings quality and mutual esteeming support to a clear process to establish a commonly shared (jointly established and accepted) appropriate quality. The term “commonly shared” in this regard refers to the establishment (generation) of the result-to-be-achieved and thus extends to the colleagues involved, the divisions/departments of a company, the entire company, and the company boundaries to customers, suppliers and other business partners.

Due to the permanent feedback loop, repeatedly occurring patterns of mis-voting of quality of certain process members are levelled off after a short time.

An automatically generated documentation of the quality information monitors and controls the quality process in a self-regulating manner.

Following agile values are established from the successor by this quality process: Openness in the transmission of quality information; Focus on the overall result; Courage to communicate an insufficient quality; Eye level in responsibility and mutual support, but also in the feedback of good performances as well as for a quality that is commonly improved; and Commitments that are used in a plurality of interactions throughout the entire quality process.

In another aspect of the present disclosure, there is provided an intuition process as a component (or a tool) in a decision-making process/system that is applicable to individual decisions as well as team-based decisions. This intuition process is preferably applicable in a decision-making process that has two parallel decision-making sub-systems that are extrinsically linked and that are working in parallel, e.g. when using a decision-making process that is based on the decision-making process of the human's brain. Both subsystems, such as a cognitive subsystem and an emotional subsystem receive a stimulus. The emotional subsystem generates impulses that are interpreted in the intuition process. The intuition decision-making process is decoupled from a natural intuitive process. The emotional subsystem generates a conscious impulse that is often accompanied by a feeling, the so-called “gut feeling”. Whenever the cognitive subsystem 4 begins to create the coherent world view 5, a “hunch” and an “inner voice may be recognized.

The stimulus is preferably a stimulus that triggers the emotional subsystem, for instance a polar question which leads to two alternatives that are quickly decided in the intuition process without excessive use of the cognitive subsystem.

Inventively, the polar questions are reformulated such that the emotional subsystem is triggered to generate the impulse in a recognizable manner.

For the decision-making processes, the decision-making entity (=the decider)—or all those involved in the decision—an appropriate key question is designed in a designing step. Subsequently, the designed key question is presented in a presenting step. This presentation should emphasize and gain the stimulus for the decision-making system. In a catching step, intuition impulses are caught. The catching-step is preferably interrupted after 350 milliseconds. The result of the intuition process is documented in documenting step. For some decisions, a simple impulse (“GO”/DON'T-GO”) may not be sufficiently differentiating. Thus, these further process steps are added to the inventive intuition process.

The inventive intuition process in a decision-making process frees a natural intuition from the both inextricably linked decision-making systems and enables it to become a conscious, valuable and flexible decision-making tool. It is equally suitable for individual decisions and additionally provides a high benefit for team decisions and further interactions in teams.

With such an inventive intuition process in a decision-making process, any dissension between a so-called “head-decision” and a “stomach-decision”, which is often painfully conscious to the deciding entity in a decision-making process, gets a natural explanation and the dissension will be reunited in order to achieve a supplement for a safe decision. The dominant effect of the emotional subsystem can be detected during the implementation of measures using the inventive intuition and will be counteracted if necessary. So, any intuition receives a conscious framework that allows its deployment for individual and team decisions.

A further aspect of the present disclosure is the definition of a resource process. Therein, at first, the problem state is asked to obtain the current state, then the resources to be needed are asked, then the difference between the target state and the current state is evaluated and finally, it is defined what the common goal should be.

Herein necessary impulse in the emotional subsystem are initiated, which stringently activates a cognitive transformation for a solution. This can for instance be achieved with an intuition process as described herein or alternatively by using a cognitively over-formed assessment. So, an actual state is openly located within a few milliseconds or seconds. Then, a target state is defined, and expert knowledge is tapped. The necessary resources arise from the existing knowledge, and it will be completely based on this knowledge to convince the other participant of the process. So, the process participant gets trust but in parallel has the duty to outline a solution from his point of view. The result shows both, seriousness and competence in achieving a set goal.

The resource process provides cooperation and mutual assistance. This cyclical evolutionary effect gives companies the chance to exploit their potentials and to develop them further at the same time. The resource process and its answer in the K-i-E scale leads all involved participants into a processing that automatically makes openness which is immediately visible documentation and standardized meaning; focus that is solidly anchored in the complete process of the resource process; courage due to the inner logic which allows and demands constructive feedback; discussion on eye level that leads to appreciation and automatic support; and commitment that the process is transparent.

When using the resource process, adherence to the process is made. The resource information will show both quality and cooperation. The responsibility for the content remains where governance provides for it. The resource process is not a tool to delegate responsibility.

A (human) participant may be represented as a system component in a computer system. So, a human decision-making behavior can be map to a computer logic, e.g. by applying different decision-making sub-systems related to the behavior of the human's brain, e.g. an emotion (sub) system and a cognition (sub) system. These different decision-making systems in one system component work in parallel, largely autonomously and come to different decisions at different times, based on different information and memory systems. Both decision-making systems process the same input parameters, for example a stimulus, in different ways and come to their own evaluation and specific meaning. A first decision system of a system component may process the stimulus according to a first computational logic, for example according to a statistical prediction or a heuristic procedure. The first logic is called cognitive logic or rational logic. A second decision system of the same system component may process the same stimulus according to a second logic, for example an emotion logic or less rational logic, for example based on motives. The processing of the stimulus in the second logic may be fast, effortless, unsolicited and/or inaccessible to the conscious. The first logic, the cognitive subsystem, may process the same stimulus consciously and slowly. The cognitive subsystem could be seen as a complex and multi-branched knowledge store using heuristic, analytical and statistical processes in the system component, which must be additionally activated. On the other hand, the second logic may be, for example, a spontaneous assessment based on the motive of the system participant. Both logics process the stimulus in parallel and influence each other. So, any prioritization process can be simulated in such a computer system. Each participant is represented by such a system component.

### BRIEF DESCRIPTION OF THE DRAWINGS

In the following exemplary embodiments of the invention are described with reference to drawings. Those exemplary embodiments do not limit the scope of the invention. The same reference signs in different drawings indicate the same elements or at least the same functions unless otherwise stated.

FIG. 1 An exemplary cyclic decision-making process made in the human's brain;

FIG. 2 A flow diagram of an exemplary embodiment of a prioritization process according to the invention;

FIG. 3 A flow diagram of an exemplary embodiment of a design defining step of the prioritization process of FIG. 2 according to the invention;

FIG. 4 Overview of exemplary dimensions as shown in FIG. 3 and required in the defining step of FIG. 2;

FIG. 5 An exemplary embodiment of a K-i-E scale required in the prioritization process according to FIG. 2 and its meaning in Table 1;

FIG. 6 A flow diagram of an exemplary embodiment of a deciding step in the prioritization process of FIG. 2 according to the invention;

FIG. 7 An exemplary embodiment of a K-i-E scale useful in the deciding step of FIG. 6;

FIG. 8 A flow diagram of an exemplary embodiment of an evaluation step in the prioritization process of FIG. 2 according to the invention;

FIG. 9 An exemplary embodiment of a K-i-E scale useful in the evaluation step of FIG. 8;

FIG. 10 A flow diagram of an exemplary embodiment of a committing step in the prioritization process of FIG. 2 according to the invention;

FIG. 11 An exemplary embodiment of a K-i-E scale useful in the committing step of FIG. 10;

FIG. 12 A flow diagram of an exemplary embodiment of a ranking step in the prioritization process of FIG. 2 according to the invention;

FIG. 13 An exemplary embodiment of Fibonacci numbers useful in the ranking step of FIG. 12;

FIG. 14 An exemplary embodiment of a K-i-E scale useful in the ranking step of FIG. 2 resulting in a ranking of topics based on groups;

FIG. 15 An exemplary embodiment of a prioritization maker using a handheld device with respective protocolling as a cloud-based service;

FIG. 16 A general design of a K-i-E-Scale according to the invention;

FIG. 17 A block diagram of an exemplary embodiment of a quality process according to the invention;

FIG. 18 A block diagram of an exemplary embodiment of a quality process according to the invention based on FIG. 17;

FIG. 19 An exemplary embodiment of a K-i-E scale required in the quality process according to FIG. 17 and FIG. 18;

FIG. 20 An exemplary embodiment of a K-i-E scale useful to obtain the precursor quality indicator in the quality process according to FIG. 17 and FIG. 18;

FIG. 21 An exemplary embodiment of a K-i-E scale useful to obtain the successor quality indicator in the quality process according to FIG. 17 and FIG. 18;

FIG. 22 A block diagram of an exemplary embodiment of an extended quality process according to the invention based on FIG. 18;

FIG. 23 A block diagram of an exemplary embodiment of an extended quality process according to the invention based on FIG. 22;

FIG. 24 A block diagram of an exemplary decision-making process including an intuition decision-making process according to the invention;

FIG. 25 A block diagram of an exemplary decision-making process mainly using an intuition decision-making process according to the invention;

FIG. 26 A block diagram of an exemplary decision-making process using an intuition decision-making process according to the invention;

FIG. 27 A flow diagram of an exemplary embodiment of an intuition process according to the invention;

FIG. 28 A block diagram of an exemplary decision-making process using an intuition decision-making process according to the invention;

FIG. 29 A flow diagram of an exemplary embodiment of a resource process according to the invention;

FIG. 30 An exemplary embodiment of a K-i-E scaled question useful to obtain the current state in the resource process according to FIG. 29;

FIG. 31 An exemplary embodiment of a K-i-E scaled question to ask for needed resources in the resource process according to FIG. 29;

FIG. 32 An exemplary embodiment of a K-i-E scaled question to ask how much difference there is in the resource process according to FIG. 29; and

FIG. 33 An exemplary embodiment of a K-i-E scaled question to ask for the goal to be achieved in the resource process according to FIG. 29

### DETAILED DESCRIPTION OF THE PREFERRED EMBODIMENTS

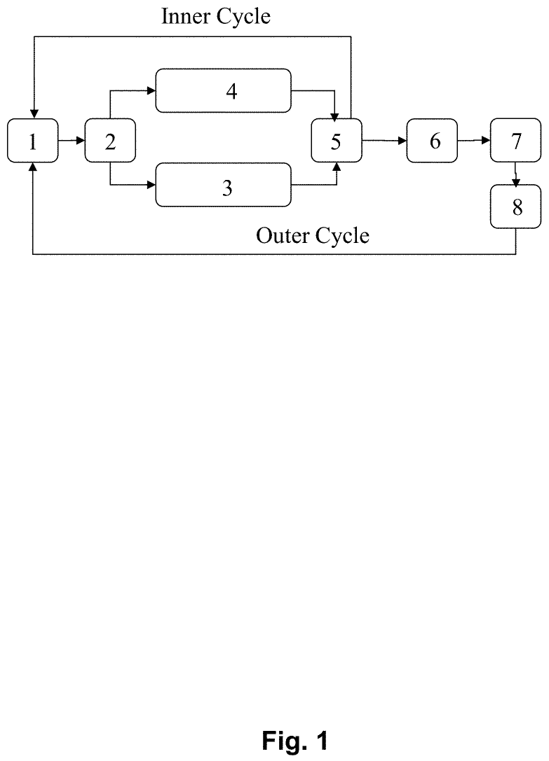

FIG. 1 shows an exemplary cyclic decision-making process made in the human's brain. Taking the human's brain as an example, everyone can decide with intuition (gut feeling) or consciously (cognitive) or in a decision-making strategy intuitively-cognitively-intuitively in more cycles.

Here, an external stimulus 1 is fed into a decision-making process. In the decision-making process, an emotion system 3 and a cognitive subsystem 4 are inextricably linked. They are working in parallel, largely autonomously and conclude decisions at different points in time based on different memory systems. The cognitive subsystem 3 creates a coherent world view 5 based on the results of both the cognitive subsystem 3 and the emotion system 2. This coherent world view 5 is recognized and evaluated by humans (“inner cycle”).

It cannot be said that the one system 3, 4 is more powerful or better than the other one 4, 3. Both systems 3, 4 may lead to reasonable or faulty decisions. Both systems 3, 4 interact. The cognitive subsystem 4 is activated by the emotion system 3.

The emotion system 3 operates without requests, is fast and restless. It operates in our subconsciousness. It recognizes the meaning of objects much faster than the cognitive subsystem 4 and activates it. A jointly supported decision 6 can be made efficiently if both systems 3, 4 base it on matching of facts (information) and assessing of motives. This assumption applies whenever the systems 3, 4 cooperate with each other and at least one of the systems 3, 4 has access to sufficient facts. This is ensured to a high degree by the diversity and the access to facts. Such a decision 6 is made on a preliminary basis. An intentional decision 6 is not a linear process and is made through cycles. Even if a decision 6 causes actions, they may and should be corrected based on the caused effects 7, indicated as “outer cycle”. Whenever an emotional motive such as concerns about safety and influence are guaranteed to seize an opportunity, good and safe decisions are made and the cycles end. The inventive prioritization process is based on this human's brain behavior.

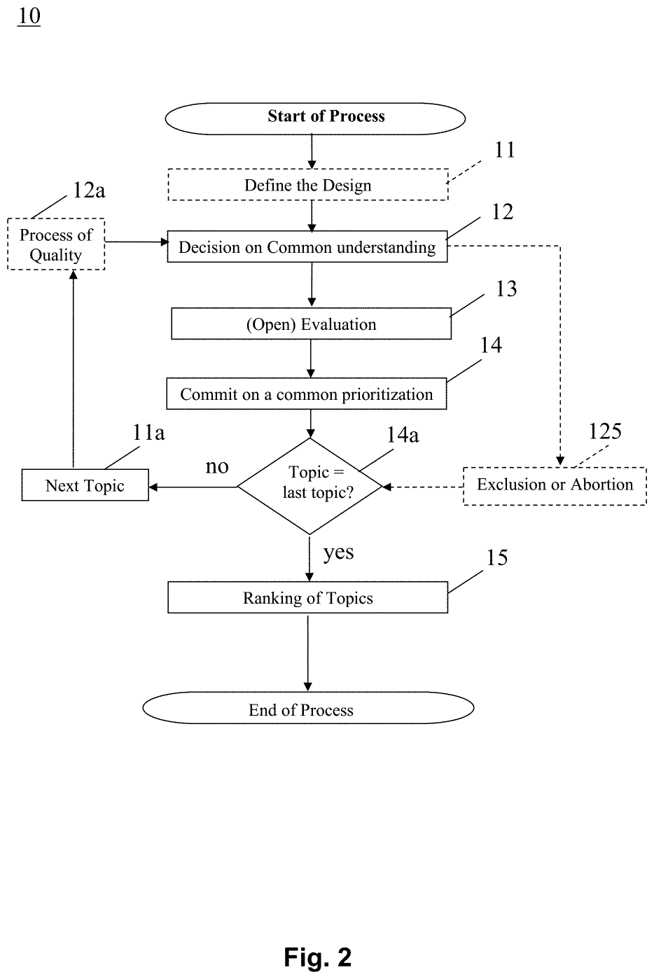

FIG. 2 shows a flow diagram of an exemplary embodiment of a prioritization process 10 according to the invention. In this prioritization process 10, following questions are solved by the responsible persons, system or component: (1) What is done in what order? and (2) What is not done? In an organization, various requirements from different areas compete for limited resources in terms of time, budget, competencies, focus and implementation capacity and resources.

The prioritization process 10 is clearly organized in five steps 11 to 15, wherein step 11 is optional, step 12 may also be referred to as phase I, step 13 may also be referred to as phase II, step 14 may also be referred to as phase III and step 15 may be referred to as phase IV.

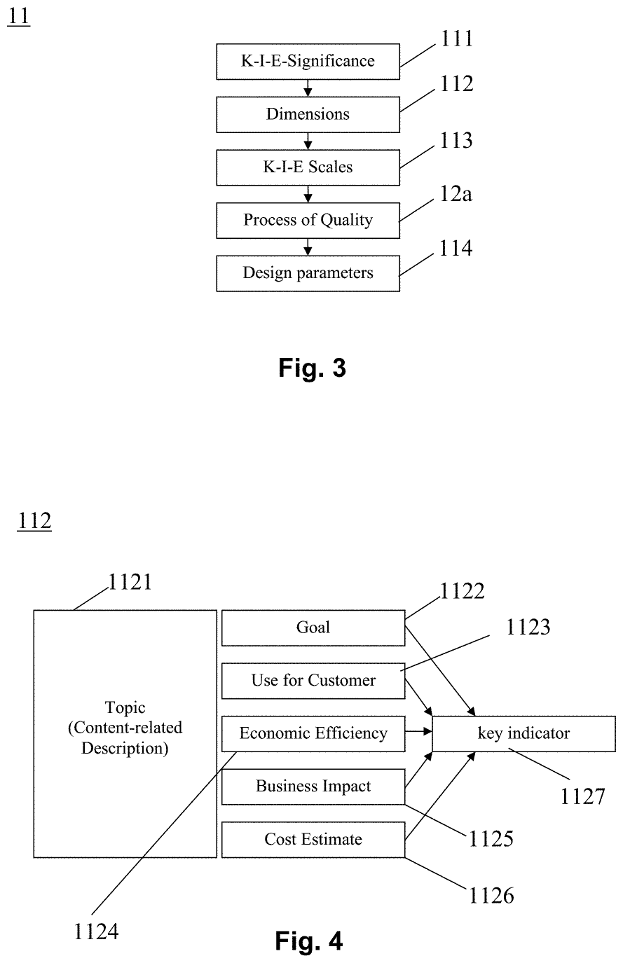

After starting the process, an optional defining step 11 is performed, as will be described in greater details in FIG. 3 to FIG. 5 and table 1 below. In this preparatory defining phase 11, the prioritization process 10 is adapted to actual requirements and goals. The design is produced as a commonly shared decision with those who are responsible and is introduced and maintained as a change process.

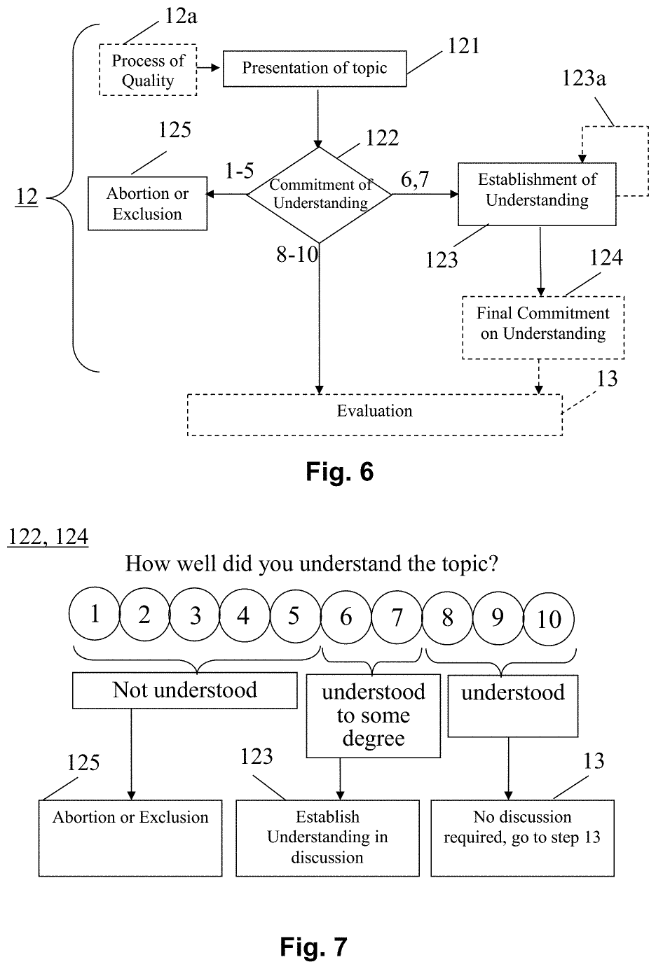

Subsequently, each topic out of a plurality of topics is to be ranked according to the prioritization process 10. Therefore, a deciding step 12 (phase I) is performed to decide whether a common understanding of a specific topic exists. Every topic will be classified into three ranges, namely (1) understood; (2) reasonably understood; (3) not understood. To increase stability of the inventive priority process 10, a preceding process of quality 12a may be performed to bring the class (2) reasonably understood to the class (3) understood. The deciding step 12—as explained in greater details in FIGS. 6 and 7—may result in an exclusion of that specific topic or an exclusion of a participant or an abortion of the process, indicated as reference 125.

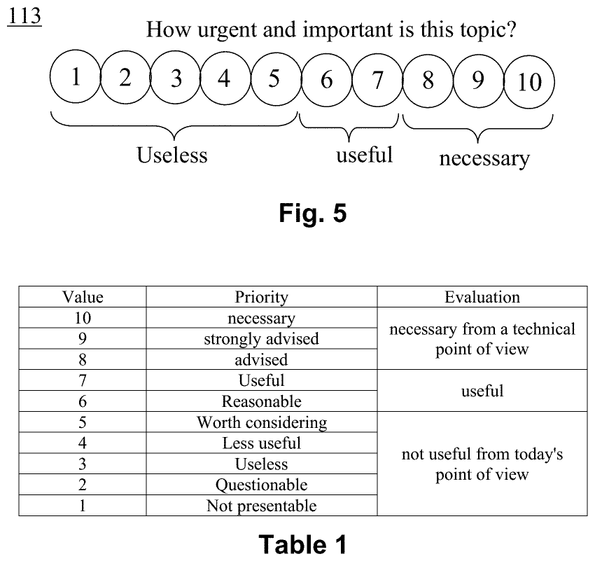

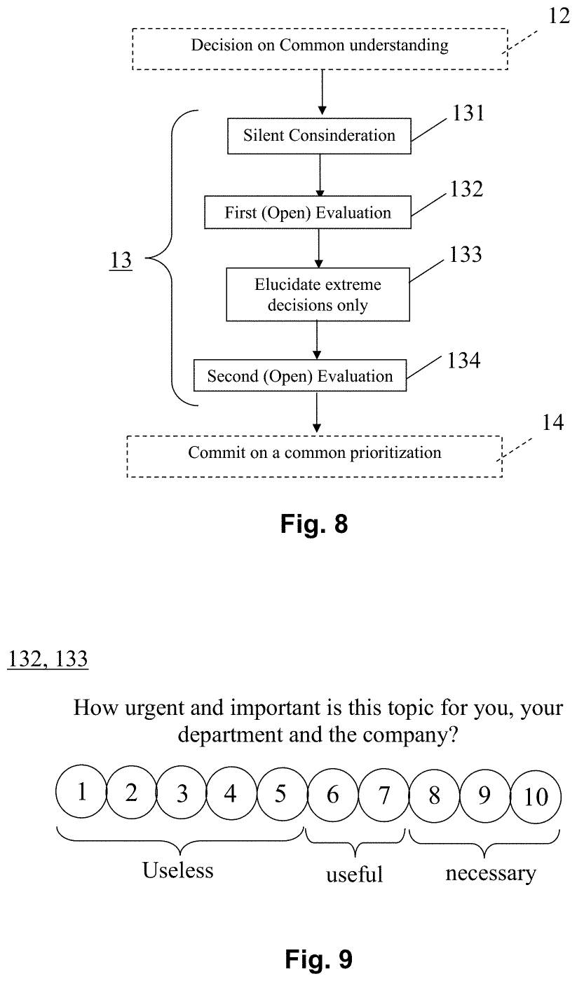

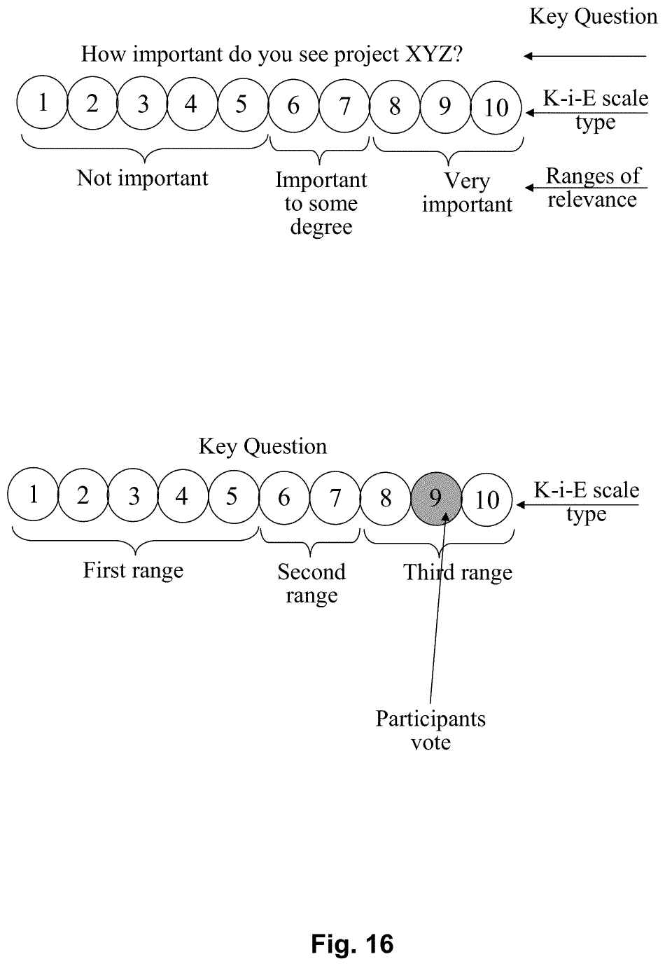

If a common understand on the specific topic could be decided in deciding step 12 an evaluation step 13 (phase II) follows. The evaluating is preferably an open (=not hidden) evaluating, which means that every participant can see the evaluation result of the other participants. In step 13 it is open evaluated that specific topic according to its urgency and importance for the desired objective by using one priority indicator represented by a scale of ten different values from every participant. The priority indicator classifies a specific topic into three ranges, namely (1) necessary topics that are pursued with high priority; (2) meaningful (=useful) topics to be tackled with low priority; (3) not meaningful (useless) topics, which are not pursued further. An exemplary embodiment of such a priority indicator is shown in FIG. 5 and the meaning of the different values are mapped in table 1. FIGS. 8 and 9 will explain the evaluation step 13 in greater details. Such a priority indicator should be based on a scale having ten different values, such as the K-I-E scale. An exemplary explanation of the K-I-E scale can be derived from FIG. 16 below.

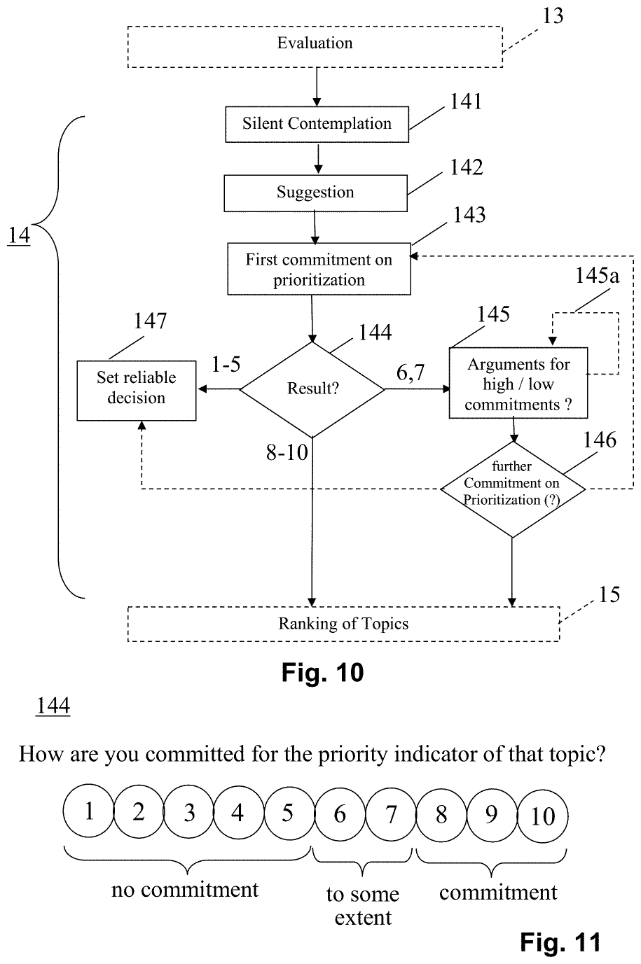

In a committing step 14 (phase III) that directly follows the (open) evaluation step 13, a commonly shared (jointly supported) prioritization of that specific topic is made. The committing step 14 is explained in greater details in FIGS. 10 and 11. The committing step 14 is preferably based on a committing process as described in U.S. Ser. No. 16/227,483, filed on Dec. 20, 2018 by the same applicant and which is incorporated by reference.

If no commitment of the commonly shared prioritization (as expressed by the priority indicator) is reached in step 14, a master or an algorithm that is declared to be a master, as agreed in the defining step 11, will decide. In step 13 and step 14 there is no abortion or exit, which is an important characteristics of the inventive prioritization process. Once that there are no interruptions possible, the prioritization process reaches a safe end.

At the end of these three phases I to III, a commonly shared commitment on the prioritization of a specific topic is achieved or a specific topic is excluded from the process 10.

After the committing step 14, it is determined in step 14a whether a commonly shared (jointly supported) prioritization of all topics has been made. If the determination 14a results in “No”, the next-topic 11a is chosen and the steps 12, optionally 12a, 13, 14 are repeated to obtain a commonly shared commitment on this next-topic 11.

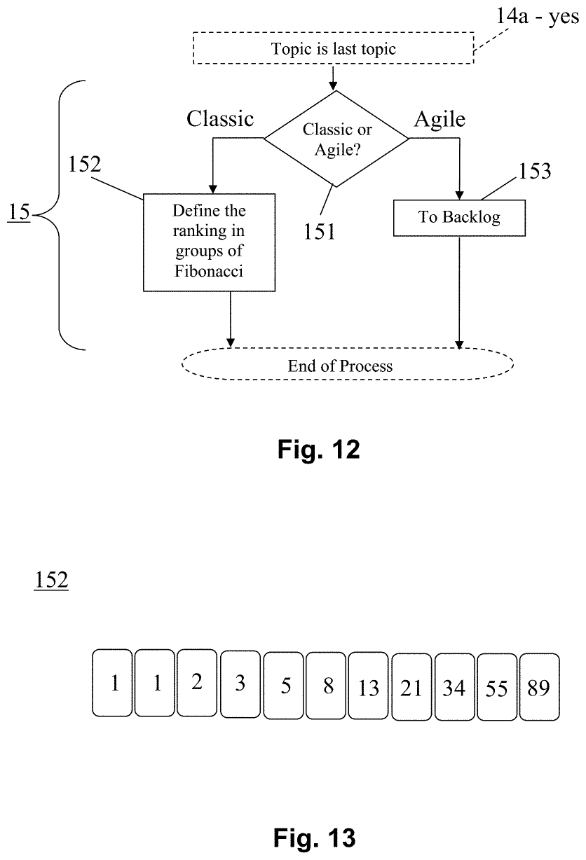

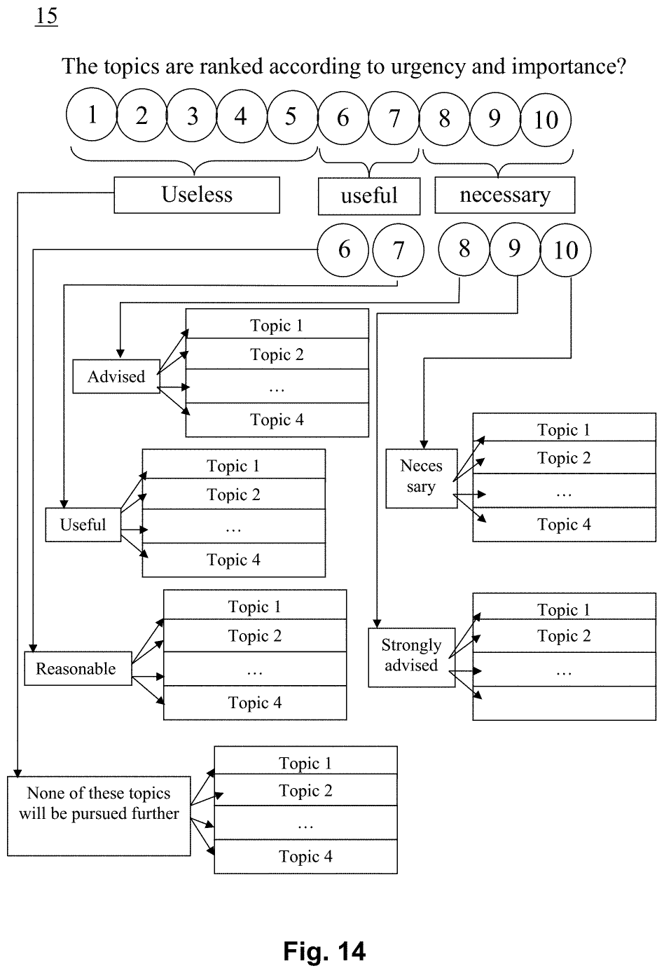

If a commonly shared prioritization is committed to all topics to be ranked (Yes-case of step 14a), a ranking step 15 to rank the topics will be performed. FIGS. 12 and 13 will explain the ranking step 15 in greater details. The process 10 ends when the ranking step 15 is finished.

This prioritization process 10 achieves its objective of quickly and safely ranking of the plurality of topics without involvement of personal issues of the responsible persons or unrelated topics. Thus, on the one hand, the process 10 clearly guides all participants. The competence and a common prioritization are created. The same applies to a subsequent joint implementation. On the other hand, for a secure implementation, decision processes such as the commitment and prioritization process must be transparently integrated during the implementation. The implementation planning that follows directly after this prioritization process 10 is not part of the prioritization process 10 and is not described here.

The process 10 is transparently documented throughout all phases Ito IV and remains visible in later phases II to IV (steps 13 to 15). This motivates the participants to be open and supportive in the first place.

FIG. 3 shows a flow diagram of an exemplary embodiment of a design defining step 11 of the prioritization process of FIG. 2 according to the invention. FIG. 4 shows an overview of exemplary dimensions 112 as shown in FIG. 3 and useful to define the design in the defining step 11 of FIG. 2. FIG. 5 is an exemplary embodiment of a K-I-E scale required in the prioritization process 10 according to FIG. 2. A relationship between the single values of the K-I-E scale of FIG. 4 and their priority for topics to be committed in step 14 and the evaluation in step 13 is represented in Table 1. The FIGS. 3 to 5 and table 1 are described in the following.

The design is to be defined in step 11 to adapt the prioritization process 10 as well as a quality process 12a as a precautionary measure. The aim of each prioritization is to create a common selection of themes in line with the given scope. It is assumed for the prioritization process 10 (this also results from the objective), the premises, the own specifications and persons responsible, embedded in the values and strategy of the company. The scope is a constant companion in the prioritization process 10. It is recommended to visualize the scope for the process so that one can refer to it if necessary.

A commonly shared prioritization of a topic (result in step 14) is classified into three areas of meaning: necessary, meaningful (useful) and not meaningful (useless) topics. The extent to which the necessary and meaningful topics can be dealt with using the given resources is a downstream process not discussed in detail herein. Many companies talk a lot about it and spend a lot of time in prioritizing of topics, but rarely about which topics should rather not be addressed. This failure leads to a lack of focus and so, time and resources are lost. However, it is essential that any evaluation of the topic takes place before the ranking of the topic in step 15. Unreasonable topics are sorted out beforehand and are not followed. They do not even take part in the ranking step 15. Those topics can be saved and can be replayed in the backlog in later stages in which they may gain in importance.

According to FIG. 3, a parameter 111 in the defining step 11 is whether K-I-E theory is of significance for the process 10. A descriptive name that is clear for the process 10 is an important step towards success. The solution of using one priority indicator only (step 14) is technically necessary and is strongly recommended. Flexibility is maintained with such a single priority indicator. Since such a priority indicator is best presented in K-I-E theory, appliance of K-I-E is always recommended. The intuition reacts only to one question with one dimension. For more than one-dimension humans need using intuition and cognition in an individual process or a common decision-making process, what in complicated and nor reliable. The topics that have already been worked on, can be added immediately or later. So necessary changes can be integrated into the prioritization process 10.

In contrast, the frequently chosen form in companies to select individual dimensions 112 as criteria for prioritization and to merge them with a metric in a few key figures is far too short. Changes in objectives, adjustments to market challenges, but also internal necessities and re-prioritizations have an impact on the dimensions. In the current market situation, a digitization dimension would be advisable for business requirements. Previous prioritizations would no longer fit the new dimensions, and work could not continue seamlessly.

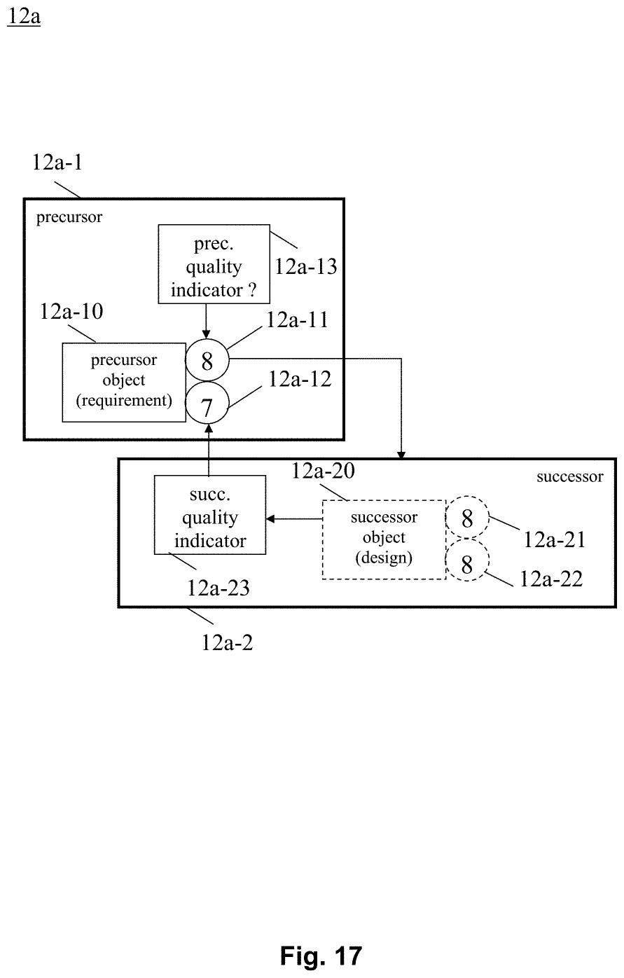

According to FIG. 3, another parameter in the defining step 11 is choice of dimensions 112. This is made with a quality process 12a as explained in greater details in FIGS. 17 to 23. The number of dimensions 112 should not exceed 5 to 7, because humans have limited brain capacity in their working memory. A cloud service or AI can handle unlimited dimensions. FIG. 4 illustrates the impact of the dimensions 112. The dimensions 112 are used to derive a single key indicator 1127, which in case of the prioritization process 10 is the prioritization indicator, and in case of the quality process 12a is the quality indicator and which for instance represents the business importance of a topic 121 in a transparent fashion. These dimensions 112 are intrinsically linked to the missions of a company. Exemplary dimension 112 are: overall-objective (goal) 1122; use-for-costumer 1123; economic-efficiency 1124; Business-Impact 1125; Estimation-of-costs 1126. A description 1121 of the topic should be applied, too.

According to FIG. 3, another parameter in the defining step 11 is the definition of the priority indicator on the basis of a K-I-E scale 113 as also shown in FIG. 5 and as mapped in Table 1 and as discussed in FIG. 16. The main question “How urgent and important is this topic?” is to be answered. In an initial phase, with inexperienced employees and especially with critical topics where conflicts of interest are obvious, a longer form of that question should be used: “How urgent and important is this topic for you, your department and the entire company?” The K-i-E scale must be committed with a commitment process according to U.S. Ser. No. 16/227,483 submitted with the USPTO on Dec. 20, 2018.

In the evaluation step 13 and the committing step 14 it will become visible who of the participants acts on a tactical basis and effects based on emotions, especially guilt and shame. This discovering will lead to a clear regulative in a steady process 10.

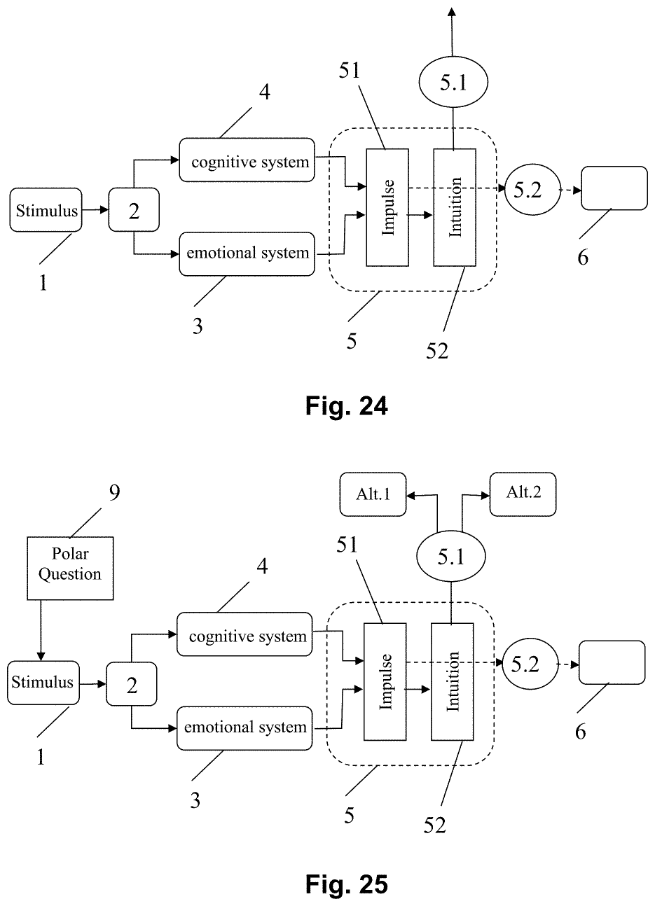

Topics are typically prioritized according to the criteria of urgency and importance, from which the values of the priority indicator are then derived: necessary, meaningful (useful) and not meaningful (useless), see also table 1. Responsible persons are faced with the task of deciding between individual, departmental and company interests in a conflict of objectives. A clear and robust logic of the priority indicator as shown in FIG. 5 is ideally equipped for this. Due to their ability to map intuition and cognition, the participants can use their intuition and then express different interests in a cognitive evaluation. In FIG. 16, the design of a K-I-E scale as a representative for a scale having ten values to express the priority indicator is explained in greater details. Such a K-I-E scale 113 based priority indicator allows a quick, standardized and accepted evaluation in steps 12, 13 and 14 that is prerequisite for the prioritization process 10, the quality process 12a and also the intuition process as shown in FIGS. 24 to 28.

Without such a single priority indicator (e.g. based on the K-I-E scale 113 of FIG. 5 and FIG. 16), only a quarter of the efficiency of the prioritization process 10 is exhausted. This is one of the main reasons why many prioritizations in companies fail, last very long and lead to unsustainable decisions. The consequences are a growing topic jamming in the backlog leading to missing measures and missing orientation in the company that have drawbacks to the business.

According to FIG. 3, other design parameters 114 should be defined in the defining step 11. Such parameters are for instance: Number of questions to be allowed in the evaluation step 13 and/or the commitment steps 14; Number of participants that should explain their vote for the resulting uppermost or lowest value of the priority indicator in the evaluation step 13. Such parameters should be defined in advance to avoid exhaustive discussion in these stages of the process 10.

A formal and closely managed design should be defined in the defining step 11 for prioritization processes 10 that are held on a regular basis. A commitment for all of the definitions is necessary to guarantee a safe and robust prioritization process.

FIG. 6 shows a flow diagram of an exemplary embodiment of a deciding step 12 in the prioritization process 10 of FIG. 2 according to the invention. FIG. 7 shows a priority indicator based on a K-i-E scale that may be used in the step 12. Step 12 (phase I) is a very important step that ensures a sufficient quality of the description of the topic to get a common understanding of the participants. Without phase I, no prioritization is possible. Experts only commit themselves when they are convinced of their success. This early process phase I (step 12) is mandatory, so that the process 10 is not interrupted in later phases II to VI or steps 13 to 15.

A quality process 12a as described with FIG. 17 to FIG. 23 as an integral part of the introduction of the prioritization process 10 may be used to define the topics and so, the topics to be prioritized are of sufficient quality. In fact, most attempts to prioritize topics are rejected in this phase I (step 12) due to a lack of quality. In order to avoid a tactical or manipulative abuse of the prioritization process 10, the quality of the documentation, e.g. description 1121, of the topic is an essential success factor and can be properly defined in the defining step 11 of the prioritization process 10.

In the following, it is assumed that all topics are prepared in the appropriate quality and are (were) accessible (in advance) to all participants. A spontaneous collection of topics is very well acceptable for prioritizations of smaller number of topics, especially when several alternatives to a topic appear in a decision-making process. It requires an experienced leader (e.g. Master the process 10) that performs the prioritization process 10 in an orderly manner. However, the procedure suffices the same structural flow diagram (FIG. 2) as for larger and formal prioritization processes 10.

According to step 121 in FIG. 6, each of the topics is presented in a defined setting. In advance it may be defined in step 11: Complexity of the topics; Competence of the participants; To what extent should the topics be presented to the participants; To what extend are the topics made available in advance to the prioritization process 10.

After the topic has been presented in step 121, it is decided by each participant whether a common understanding exists in step 122. This decision is made by an understanding indicator, as shown in FIG. 7. The understanding indicator of FIG. 7 used in step 122 that follows step 121. The understanding indicator of FIG. 7 can be based on a K-I-E scale (FIG. 16). So, a key question to all participants “How well did you understand the topic” is asked and the answers are tracked, e.g. by use of the K-i-E scale as shown in FIG. 7. If it is determined in step 122 that there is sufficient understanding (K-I-E scale scores 8, 9 or 10), it is decided that a common understanding on the topic is present and phase II (step 13) is proceeded.

However, if it is determined in step 122 that the understanding is incomplete, a regulated procedure is followed. In case, it is decided by one of the participants that a common understanding is not present and/or cannot be achieved (K-I-E scale scores 1, 2, 3, 4 or 5), the prioritization is either aborted for that specific topic or this specific topic is excluded from the prioritization process 10 or an individual participant is excluded from the prioritization of that topic (see step 125 in FIG. 2 and FIG. 6). If the understanding lies in the evaluation range from 1 to 5 and aborting for this specific topic is decided, a documentation (protocol) is made and therein it is defined what would be required to understand the topic in advance to a next prioritization process of that topic. If the master of the process 10 decides that participants voting for a value in the range of 1 to 5 are to be excluded for this specific topic, it is possible that the prioritization of that individual participants can be completed afterwards whenever they decided that a common understanding is achieved.

When it is decided by one of the participants, that the understanding is achieved to some extend (not yet achieved but achievable), some understanding questions may be asked to establish the understanding in step 123. In the defining step 11 it is defined how many understanding questions are to be asked (step 123a) and how to proceed if no understanding can be established. It is to be assumed that sufficient expertise on each topic is available from the participants involved in the process 10 or from specialists consulted during that process 10. The questions will be answered in a defined format (defined in step 11) by the expertise of the participants that are present.

An optional renewed commitment step 124 can be used to decide that a common understanding is now achieved. This is documented for the next phases (II to IV). This final commitment in step 124 is preferably achieved by the same measures as the first commitment step 122 and may be based on a K-I-E scaled priority indicator according to FIG. 7. The commitment in step 122 is included for safety reasons to limit the cycle as designed. After the exchange of information on the questions, it is finally committed that individual participants have reached the understanding. When the understanding is not reached this topic is excluded from the prioritization process 10. When a participant is excluded then the evaluation step 13 (phase II) of FIG. 2 and FIG. 8 can be processed.

FIG. 8 shows a flow diagram of an exemplary embodiment of an of an open evaluation of every participant step 13 (phase II) in the prioritization process of FIG. 2 according to the invention. In FIG. 9, an exemplary embodiment of a priority indicator based on a K-i-E scale useful in the open evaluation from every participant step 13 of FIG. 8 is shown.

The open evaluation of the business importance (=priority indicator) itself—according to step 13—is a manageable process with good preliminary work in the preceding steps 11, 12 of the prioritization process 10. According to FIG. 8, a silent consideration step 131 is followed by a first open evaluation of every participant step 132 that is then followed by a structured discussion in step 133, which aims to present the different meanings in view of topic to all participants. The diversity in meaning leads to a common view of the topic. A second evaluation step 134 enables the final open evaluation.

In the first step 131 of phase III (step 13), a silent observation is used by each participant to make own observations without influencing others and without being influenced by others. The participants are given the opportunity to recall their intuition and bring it into line with the cognitive evaluation. Any contradictory individual, departmental and company interest can be reconciled.

In the first open evaluation step 132 a priority indicator according to FIG. 9 is used to evaluate the topic from every participant. Here, a key question: “How important and urgent is this topic for my department and for the entire company” is asked and the answers are collected and defined according to FIG. 9. The participants can make a conscious decision and choose one of the value 1 to 10 for their evaluation. His/her choice is concealed and is only revealed after all participants have presented their vote. Through this procedure in step 132, mutual influence and anchor effects are eliminated. All participants will come with a standardized rating at the same time.

The results of step 132 are revealed. So, very quickly, e.g. in one to two minutes all participants and if necessary, the leader of the process 10 obtain a first insight. The inner logic of a priority indicator presented via a K-i-E scale (according to FIG. 9) already shows how close the votes are for a common business importance or how far away they are from it. Up to this point, there are usually no disturbing interactions in the entire process 10. Discussions, attempts at persuasion, devaluations or revaluations, self-portrayals or returns for frictions of the past are eliminated by such a process step 13 in the prioritization process 10.

No emotional loops emerge (as described below) because they cannot be initiated by such a design of the prioritization process 10. It becomes immediately apparent to everyone how far one deviates from a common evaluation.

The first evaluation step 132 made by the group is the first common step in the process 10. The picture of the evaluation in this step 132 is already a first jointly developed result, regardless of the extent to which the evaluations themselves agree in terms of content. The leader of the process 10 (=master) respectively the process itself signals the following to the team: From here it is a matter of doing something together in order to achieve a joint open evaluation and following prioritization.

In step 133, participants that voted with the lowest value and those who voted with the highest value (assuming a K-I-E scale-based priority indicator is used) are invited/forced to explain their reasons for the business-importance. The lowest value can either be a value of the K-I-E scale or can be a group value, wherein the groups are defined according to FIG. 9 with: lowest group representing values 1 to 5 (Useless); middle group representing values 6 and 7 (Useful); uppermost (highest) group representing values 8 to 10 (necessary).

The number of participants to speak is a parameter that is defined in the step 11. In practice, two participants per lowest and highest value seem sufficient. In order to maintain an anonymous process, the participants are not asked in turn, but someone randomly chosen from the group of lowest/highest value-voting is asked to explain in step 133. The participants with the higher value are explaining their view first.

With this process step 133, the expertise of individuals is made available to the entire group of participants. There are good reasons for the respective assessment at the lowest and highest values of the priority indicator. The participants refrain from convincing others, which would only initiate emotional loops. The presentation of the different polarizing positions provides the necessary information to prepare a prioritization to each individual in the group. In this way, the individual as well as departmental and company concerns can be considered by all. The transparency of the process 10 prevents any tactics in this step 133. An open justification would reveal such a tactical behavior sooner or later in a follow-up phase (III, IV). A solid justification enriches the group with insights that were previously were not present.

In step 134, a second evaluation is made, wherein the insights gained from the group are now used to make a second vote. Experience has shown that this process step 134 brings together the assessments of the participants in an established and steady prioritization process 10. The second open evaluation 134 is made in the same manner as the first evaluation.

In just a few minutes, this phase II (step 13) provides a clear picture of the evaluation of the entire group. A later distancing or change of the business importance is prevented by the transparent documentation.

FIG. 10 shows a flow diagram of an exemplary embodiment of a committing a single priority key step 14 in the prioritization process of FIG. 2 according to the invention. FIG. 11 shows an exemplary embodiment of a priority indicator based on a K-i-E scale useful in the committing step 14 of FIG. 10 (and FIG. 2).

The step 14 (phase III) aims to establish a common prioritization for each topic that is expressed by a committed single (one) priority indicator. In this phase III, the team is guided closely through the previously defined design of the common prioritization. This inventive design of the process 10 guarantees a commonly agreed priority indicator. Based on the individual evaluations for a specific topic in step 13 so far, a common prioritization will be forced in this phase III. The various individual views provide information as to how far the team is away from a common prioritization.

In step 142, the leader of this process 10 (master) determines a meaning from his experience or a committed algorithm, which is derived directly from the image of the open evaluations.

Subsequently in step 143, the individual meanings in view of the specific topic are exchanged in a closely conducted discussion with the aim of converging towards a committed priority indicator that leads to the commonly shared prioritization of that specific topic. On this basis, a committed priority indicator for each individual topic is established in step 143. The prioritization itself is an automatically generated result and the topics can be ranked based thereon. The topics are ranked in the common order: necessary (10), strongly advised (9), advised (8), useful (7) and reasonable (6), see also FIG. 5 and table 1.

In step 141, again a silent consideration is performed. This enables each participant to recall his intuition and to harmonize it with the cognitive evaluation.

In step 142, the leader of the process 10 is responsible for creating a proposal (suggestion) for a business importance, which is specified for a commitment by all. The metric of how a priority indicator is gained from the individual values (FIG. 11) is part of the design. Essential is, that the value as the priority indicator used in this process 10 is a natural number, integer from 1 to 10. The arithmetic mean is only conditionally suitable, because it considers outliers too strongly. In the step 142, the leader makes a good choice, which is corrected by the group if necessary.

In step 143, a first commitment for prioritization is made. The leader poses the leading question “How are you committed for the priority indicator of that topic” as shown in FIG. 11.

The first commitment in step 143 is executed in hidden form without discussion and the results are uncovered after everyone has given his vote. If the committed priority indicator for this commitment is in the range of 8 to 10 (step 144), there is a commonly shared priority indicator for that topic.

In case, it is determined in step 144 that in the first commitment step 143 some participants voted with a committed priority indicator in the range of 6 to 7, a defined number of arguments for high and low commitments for the priority indicator is allowed in step 145a to find a commonly shared priority indicator in step 145. The number is defined in step 11. These arguments are presented from the individual expertise that enriches the group know-how and favors the chance for a second successful commitment of the priority indicator in the next step 146.

After the presentation of the arguments in step 145, a further commitment is used. However, it is the process leader's (=master) choice in step 146 to again recommend his priority indicator; whether to respond to the discussed arguments as presented in step 145 and/or whether to subsequently ask the same key question (FIG. 11) again to obtain a commitment for the priority indicator.

If in step 144 it is determined that one or more participants do not commit themselves to this priority indicator (value 1 to 5) or the master decides in step 146 that a common priority indicator cannot be obtained (value 6 and 7), the commitment 14 for a commonly shared priority indicator is failed and a designed action according to step 147 is executed. In this step 147, the Master of K-i-E may decide the commonly shared priority indicator on his own responsibility. Alternatively, in step 147, an algorithm determines the commonly shared priority indicator or the commonly shared priority indicator for that specific topic is determined by a responsible person with an authoritarian decision. Alternatively, an authoritarian decision delegates this specific topic again in the prioritization process 10, which should be avoided, because it may lead to an endless loop, which would undermine the stability and safety of the prioritization process 10. The appropriate action in step 147 (setting of a reliable decision) is defined in the design step 11. If an authoritarian decision is decided, the number of cycles for the steps 144, 145, 145a, 146 has to be defined in the design step 11. After the defined number of cycles have been processed, in step 146 the master or an algorithm will decide to set the reliable decision in step 147.

In the long run, the decision of the master or the algorithm or the responsible person in step 147 has the effect that the team tends to force its own joint decision.

As can be seen, there is no exit in the commitment step 14. This is an important feature of the prioritization process 10 that there are no exits in steps 13 and 14.

Governance specifies how to proceed in the event of a failed commitment for prioritization as identified in step 144. If a commitment is mandatory for certain topics or if a jointly supported decision is required, it is recommended to use a resource question directly in the process 10 in order to still achieve a jointly supported priority.

A commitment process required in step 14 is for instance described in U.S. Ser. No. 16/227,483 filed on Dec. 20, 2018 from the same applicant. That commitment process transforms reservations into meaningful actions is a solid way to still generate a commitment in the step 14 (phase III).

However, if governance pretends that an exit according to step 125 is to be followed by an authoritarian decision, the person responsible will always be assisted by an assessment of the participants based on the previously developed picture. The transparent prioritization process 10 ensures through this procedure that with increasing experience the group prefers a jointly supported (commonly shared) prioritization rather than passing an uncertain authoritarian decision on to the leader.

In practice, it has proven successful for the exit to let the person responsible make an authoritarian decision without back bond. This guarantees a fast and safety prioritization process 10. Phase III (step 14) also produces a clear and comprehensible result in short time periods, such as a few minutes.

FIG. 12 shows a flow diagram of an exemplary embodiment of a ranking step 15 (phase IV) in the prioritization process of FIG. 2 according to the invention. FIG. 13 shows an exemplary embodiment of Fibonacci sequence useful in the ranking step of FIG. 12.

FIG. 14 shows an exemplary embodiment of a priority indicator using the K-I-E scale useful in the ranking step 15 of FIG. 2 resulting in a ranking of topics based on groups.

Phase III automatically provides a pre-prioritization in the form of a ranking of topics in five groups from necessary (10, 9, 8) to useful (6, 7) and a group of topics that is useless (1 to 5). The standardized priority indicator enables that the outcome of phase III of the prioritization process 10 can be directly integrated into an existing backlog of an agile method. So, it is merely to decide in step 151, whether an agile method or a traditional (conventional) method is applied. Thus, the process 10 shows its suitability for the agile world as well as for the traditional classical world.

For many companies, it is essential and a first big gain that useless topics (values 1, 2, 3, 4, 5) are clearly identified and that these topics are not followed. Rough sorting of the topics provides the order with groups of the priority indicator for values 10, 9, 8, 7, 6 as shown in FIG. 5 and table 1. If agile methods are used (case “Agile” in step 151), agile teams are given the task of tackling the necessary topics (10) first, before (9) and (8) with respective significance. They end up in the backlog 153 like the useful (7) and reasonable (6) topics. The topics with the highest priority—e.g. necessary (10)—are discussed in refinement meetings and finally selected in the sprint planning by the agile development team.

If a classic approach is used (case “Classic” in step 152), the individual groups (10 to 8 and, if necessary, 7 and 6) are put in a specific ranking as indicated in FIG. 14. The rank of the topics is a much easier task, because the topics are pre-prioritized in groups with priority key groups of (10, 9, 8, 7 and 6).

It is recommended to use Fibonacci numbers as shown in FIG. 13 for this purpose, depending on the number of participants and the number of topics in the respective meaning group. The Fibonacci numbers are excellently suited for cost estimates and weightings, since Fibonacci numbers are strongly related to the golden ratio: Binet's formula expresses the nth Fibonacci number in terms of n and the golden ratio and implies that the ratio of two consecutive Fibonacci numbers tends to the golden ratio as n increases.

Herein, the Fibonacci numbers, commonly denoted Fₙ, form a sequence, called the Fibonacci sequence, such that each number is the sum of the two preceding ones, starting from 0 and 1. That is F₀=0, F₁=1 and Fₙ=Fₙ₋₁+Fₙ₋₂, for n>1. F₂=1. F₀=0 is omitted. Thus, the first eleven values of that Fibonacci sequence are:
1, 1, 2, 3, 5, 8, 13, 21, 34, 55, 89

As alternative a strongly scaling number series can be chosen for the classical approach.

The prioritization process 10 as described above is a standard process that is methodologically and structurally suitable for all types of prioritization in a professional and personal context. Due to the clarity and robustness of the process 10 it is suitable for small companies as well as for corporate groups. In larger companies, several areas are involved in a topic, such as management, business development, strategy and methods, sales, marketing and, depending on the different business areas. Preparation, organization and process severity must be adapted to the number of participants.

The process 10 has proven itself in this form in many areas, for example in portfolio management for strategic corporate development, for the M&A integration and transformation process and for requirements management in projects. The prioritization process 10 is of particular importance for the agile methodology that has been used so far. The missing operationalization in SCRUM and other agile methods will be effectively supplemented with the prioritization process 10, using a priority indicator on the basis of a K-i-E scale (FIG. 16), a quality process as described in FIG. 17 to FIG. 23 and a commitment process (as described in U.S. Ser. No. 16/227,483 of Dec. 20, 2018, filed by the same applicant).

For a digital transfer, the prioritization process 10 becomes the indispensable tool. The scope of use ranges from the ideation process to implementation with agile methods.

For the personal context, a reduced prioritization process 10 is suitable for any topics, for the daily planning of work as well as for the annual selection of the opera performances and holiday planning.

The prioritization is to be introduced as a change process on the basis of a stringent design and to be to steady. It is strongly recommended to use the K-i-E scale as described with FIG. 16 below, the quality process as described in FIG. 17 to FIG. 23 and commitment process as described in U.S. Ser. No. 16/227,483 filed on Dec. 20, 2018 which is incorporated by reference for this purpose to train in advance and to adapt the individual K-i-E Tools to the peculiarities of the company and its requirements in a functional sequence. The K-i-E theory should always be considered as a framework. An essential success factor is the leader of the processes 10 (master of K-i-E) for complex decision processes. The decision as to how far it ensures process loyalty in the introductory phase or in the long run the process is anchored in, is to be implemented in accordance with the prevailing situation in the company plan.

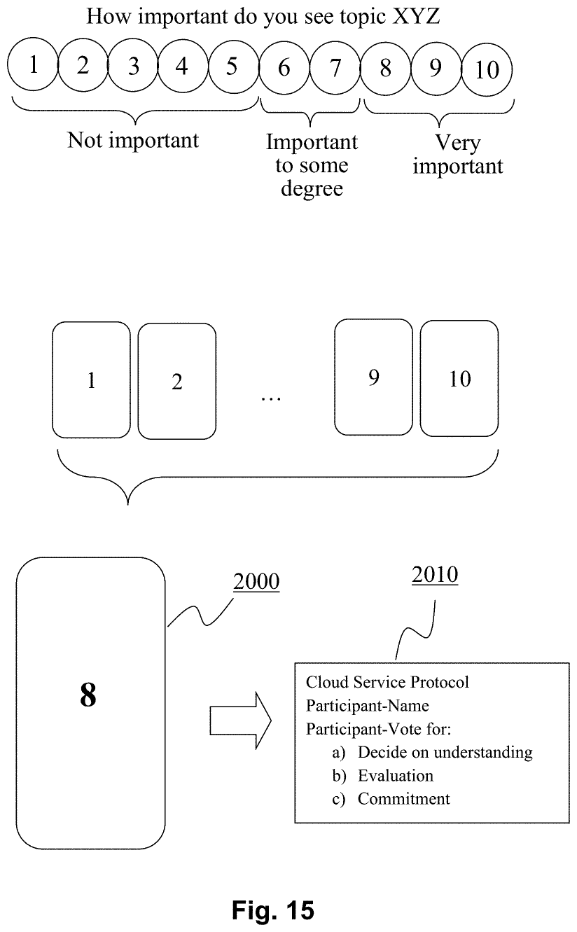

FIG. 15 shows an exemplary embodiment of a prioritization maker using a handheld device with respective protocolling as a cloud-based service or AI. FIG. 16 shows a general design of a K-i-E-Scale according to the invention.

The use of K-i-E cards to obtain the numbered answer to questions and the K-i-E app have proved their worth up to a group size of 16 participants. For larger groups, posters with adhesive dots or a software solution like the K-i-E Decision Maker should be used. An exemplary embodiment for such a software solution is illustrated in FIG. 15. Here, an exemplary K-i-E-scaled based question is asked. Each participant comprises a decision maker software installed and running on his handheld device 2000, such as a smart phone running a “K-i-E application”. Each participant inputs only one of the values 1 to 10 into his handheld device, e.g. by touch inputting means. A confirmation may additionally be required. Subsequently, a decision maker cloud-based service collects all inputted values and protocols the result in a protocol 2010. Such a protocol may contain the following items: Number and Identification of each participant. Votes of each participant for each K-i-E-scale based question. So, the prioritization process 10 becomes a high degree of transparency and destructive participants can be identified easily, e.g. participants providing unreasoned values. Such participants behavior can be identified quickly and an exclusion from the prioritization process 10 of this participant may speed-up the prioritization process 10.

So, the inventive prioritization process 10 can be implemented as a software solution, e.g. a cloud-based service as shown in FIG. 15. Each participants handheld is connected to the prioritization maker and runs the “K-i-E application” on the handheld. A decision-making application automates, guides and protocols each step in the prioritization process 10. This application may be used to guide a master of the prioritization process 10 through the prioritization process 10.

The material and the design of the K-i-E scales are to be prepared for specific target groups and topics. Larger groups require more effort. Again, experiential knowledge that has already manifested itself in neural emotional program is of high value. After the prioritization process 10 has been introduced, it takes just a few minutes to rank the topics. With high commitment culture, measurements show a time of 8 minutes for a decision that is preeminent with high quality.

FIG. 16 shows a general structure of a K-i-E scale-based priority indicator. Each K-i-E scale-based priority indicator has a key question to be asked to each participant, e.g. “How important do you see topic XYZ?”. This key question has to be answered by each participant. The answer is provided by a 10-level K-i-E scale, ranging from value 1 to value 10. This range is fix, is not extendable and not exchangeable. The 10-level K-i-E scale has different ranges of relevance. These ranges are also fix, namely that values 1 to 5 correspond to a first range, values 6 and 7 correspond to a second range and values 8 to 10 correspond to a third range. The first to third range increases its relevance, starting with the first range being rather low, the second range being higher than the first range but lower than the third range and the third range being the highest relevance. Each participants can choose only one value from this particular K-i-E scale and this chosen value (=vote) is provided to the decision maker for evaluation and protocolling. One other example without further drawings is provided in the following:

Through repeated experience, individual people develop more fearful or influential neurological emotional programs, which express themselves in behavior as personality profiles (motives): in a “scepticist” and in a “conquester of success”. These two are incompatible without an orderly commitment process, causing recurrent disruptions that waste enormous time, losing sight of the goal and frustrating the rest of the team. In the inventive commitment process, these concerns are considered and the strength of both “scepticist” and “conquester of success” is used advantageously.

On exemplary example is the so called “Calibrated Emotional Loop”. Such a loop is triggered over and over again when “sceptistics” and “conquester of success” are incorporated without control. The emotional feelings of “anxiety” or “anger” arising in this process vary from unpleasant to unbearable depending on the emotional arousal. Every decision maker knows these situations. Sooner or later, escalations and associated frictions will be directly linked to a stimulus. Most of the time, the whole team breathes at the first word, no matter whether they are worried about the subject or their success. As a consequence, the team internally turns away from the project, the focus is lost, no valuable decision is possible, and the success is endangered.

The so-called group dynamics takes its course. Due to his influence “anger”, the “conquester of success” triggers/causes “anxiety” in the dysfunctional area at the “sceptistics”, which increases a blockade behavior. The blockade again leads to a higher influence (“anger”) which finally leads to a blockade in the decision-making process. After such a mutual activation of the neuronal emotional programs in the dysfunctional area in both “scepticist” and “conquester of success”, the emotions and the involved accompanying symptoms last even longer. With appropriate emotional arousal and secreted biochemistry, this can last for hours. During this time, decisions and ratings are distorted accordingly. Fatal is the long-term effect when this calibrated loop repeats itself.

The inventive prioritization process 10 provides a clever work around for that and such loops vanish in prioritization process 10: The prioritization process 10 sets an evolutionary and clear order: first concern for security (fear) and then influence (anger) to the opportunity to use. This reduces the likelihood that the loop will reappear. If the team goes into a calibrated emotional loop, it has to do with the prioritization process 10 to return to an orderly process.

The prioritization process 10 aligns the group and releases the competence of all participants. When the emotions are used in their natural sequence, the group dynamics are aligned to a common goal. The competence of all comes to the development. Of course, this endeavor is supportive, but it does not help much if the competence is blocked by calibrated emotional loops or devalued by escalations. Many projects have sufficient experts and the necessary competence. The participants do not fail because of their individual abilities, but because of the interaction of the emotions, which always act through the inseparability of the decision-making system, whether one wants it or not. It is expected that the effect of calibrated emotional loops with several proven experts will be more significant, especially the effect of the emotional shame.

In the following, a quality process 12a is described. This quality process 12a is for instance applicable in above described step 12 (decision on a common understanding) of the prioritization process 10, see also FIG. 2 or FIG. 6.

In FIG. 17, a core concept of the quality process 12a is shown. In a first step, a precursor object 12-a-10 (also referred to as “requirement”) is transferred from a precursor 12a-1 to a successor 12a-2. During this transfer, a precursor quality indicator 12a-11 is self-estimated by the precursor 12a-1 (e.g. a responsible entity thereof) and is also provided to the successor 12a-2. In a second step, the successor 12a-2 reflects a quality of the precursor object 12a-10 with an own successor quality indicator 12a-12. Based on these two quality indicators 12a-11 and 12a-12, a quality information for the precursor object 12a-10 is obtained. This quality information is expressed as a 2-tupel information, namely: (precursor quality indicator 12a-11; successor quality indicator 12a-12). In FIG. 17, the quality information is (8; 7). The successor quality indicator 12a-12 from the successor 12a-2 is the basis for a self-organized process quality 12a to obtain a successor object 12a-20, also called “design” in the successor 12a-2 with a commonly agreed quality. The precursor quality indicator 12a-11 in combination with a difference between the successor quality indicator 12a-12 and the precursor quality indicator 12a-11 are the basis for monitoring and controlling such a self-learning quality process 12a.

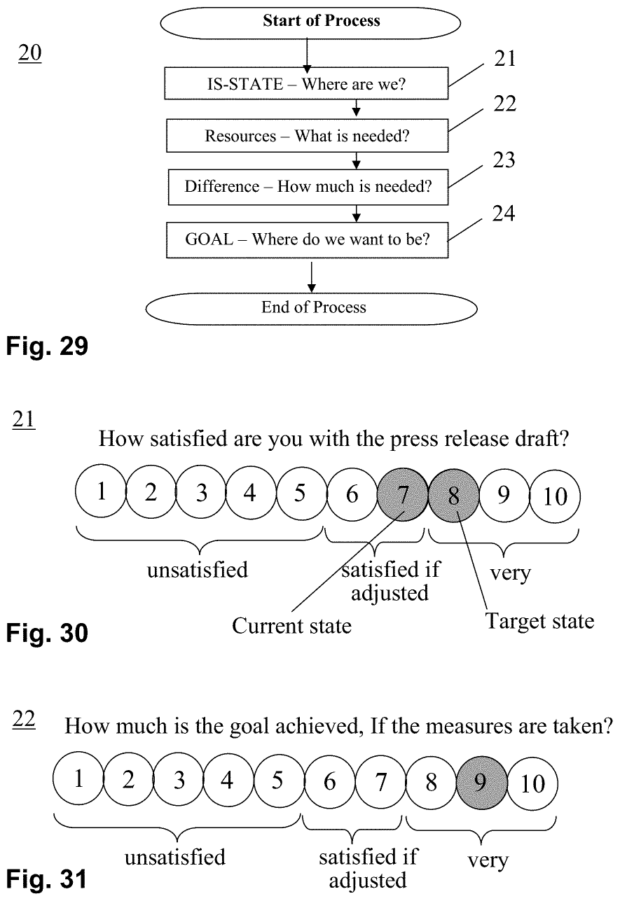

The quality information of FIG. 17, here (8; 7), has a difference “−1” that expresses that a quality can be obtained (solved) in a resource-oriented manner in a dialogue between the successor 12a-2 and the precursor 12a-1. A successor's 12a-2 responsibility has to be clearly and supportively addressed in a resource process as described with FIGS. 29 to 33 so that the successors quality indicator 12a-12 can be increased from a value “7” to a value “8” as indicated by planed successor object 12a-20 with successors quality indicator 12a-22. Further, a precursor's 12a-1 responsibility is to establish the quality on its own by using the provided resource information. Using a successor quality indicator 12a-12 with a certain value, in case of using a K-i-E scaled quality indicator, value “8” would be suitable, the successor 12a-2 signals that the quality is good enough to independently establish the process result for the successor object 12a-20 (“design”) by the successor 12a-2.

With the quality process 12a as shown in FIG. 17, the parties involved produce an appropriate and accepted quality in a self-organized multi-stage quality process 12a. The automatically generated documentation monitors and controls the process in a self-regulating manner.

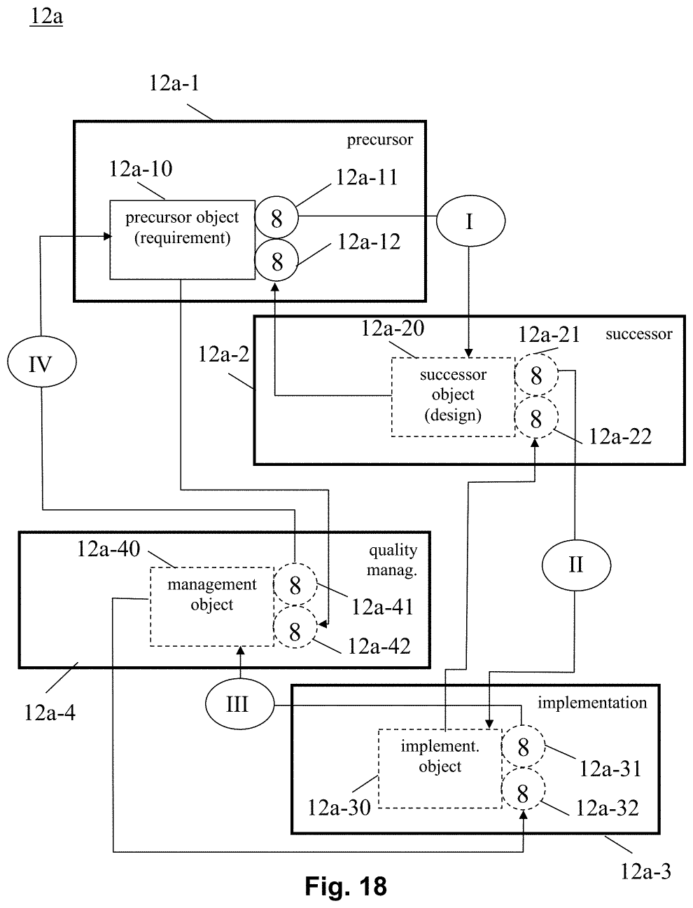

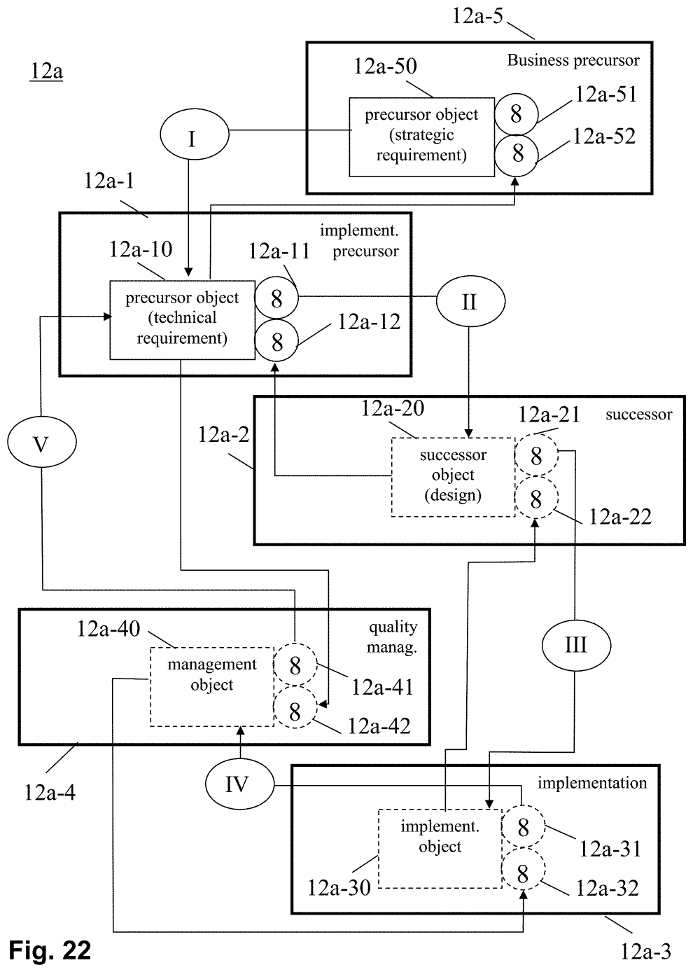

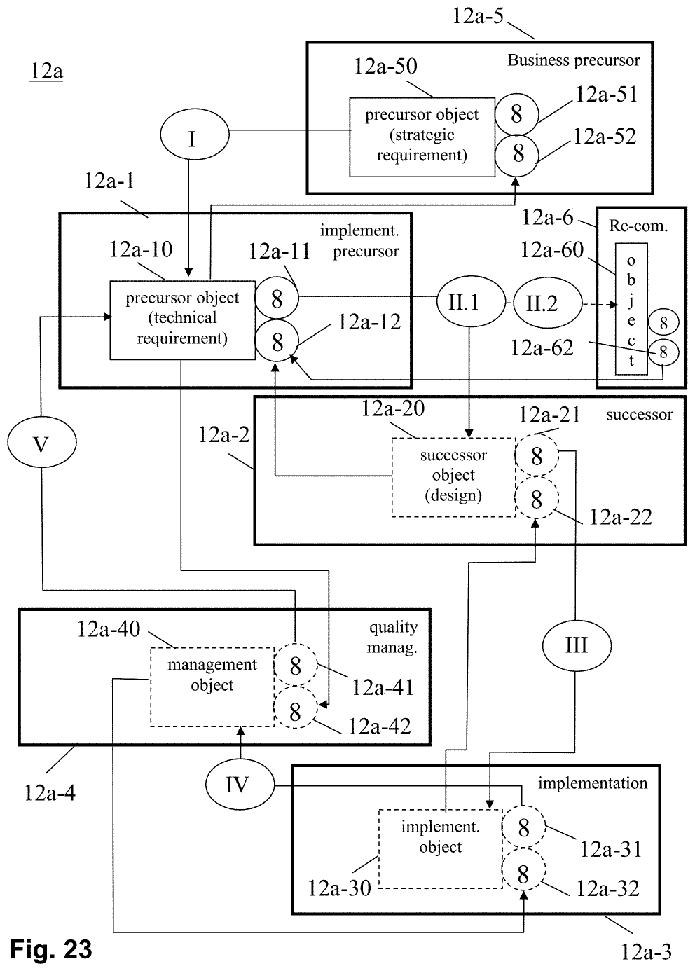

The achieved quality information will be used in follow-up processes and process steps as indicated by quality indicators 12a-21 and 12a-22 linked to the successor object 12a-20—or in view of FIG. 18, FIG. 22 and FIG. 23 by quality indicators 12a-31 and 12a-32 linked to the implementation object 12a-30; or quality indicators 12a-41 and 12a-42 linked to the quality-management object 12a-40; and so on.

The quality indicator 12a-21 as shown in FIG. 17 may be referred to as precursor quality indicator in a directly following process. The quality indicator 12a-22 as shown in FIG. 17 may be referred to as successor quality indicator in the directly following process.

The precursor quality indicator 12a-11 and the successor key indicator 12a-12 are created and communicated using a K-i-E scale according to FIG. 16. Well-experienced teams, in particular when applying agile methods, a K-i-E intuition as explained in FIGS. 24 to 28 is used by team members to achieve a quick rating. The attitude of jointly producing an appropriate quality is anchored in this quality process 12a.

Specifically, any expert estimation should be based on the K-i-E scale as shown in FIG. 16, a K-i-E intuition according to FIGS. 24 to 28 and the K-i-E resource process 20 according to FIGS. 29 to 33.

The prerequisite for an automatic documentation and the self-regulation of that inventive quality process 12a is the definition of the quality indicators 12a-11, 12a-12 for the object 12a-11 to be processed. This quality indicators 12a-11, 12a-12 are passed through all quality process steps, according to FIGS. 18, 22 and 23 indicated as precursor 12a-1; successor 12a-2; implementation 12a-3; and quality-management 12a-4.

Necessary dimensions for the quality to be achieved are commonly defined in advance. Such a defining step is quite similar to the defining step 11 as described in view of the prioritization process and it is kindly referred to the above description to avoid unnecessary repetition and FIGS. 3 and 4 above. Such a defining step 11 is processed in advance. It is (again) recommended that, in addition to the (individual) content description 1121, the dimensions are limited to five to seven dimensions. Above mentioned dimensions, such as goal 1122, use for costumer 1123, economic efficiency 1124, business-impact 1125 and cost-estimate 1126 may be used. Further, a dimension completeness may be used, that describes the completeness of internal channels in the company (not shown in FIG. 3 or 4 above). All these dimensions lead to a common key indicator 1127. In the quality process 12a, this key indicator is referred to as a single quality indicator 12a-xx that unites all the dimensions 1122 to 1126. Each of the dimensions 1122 to 1126 may be defined using a K-i-E-scale as shown in FIG. 16.

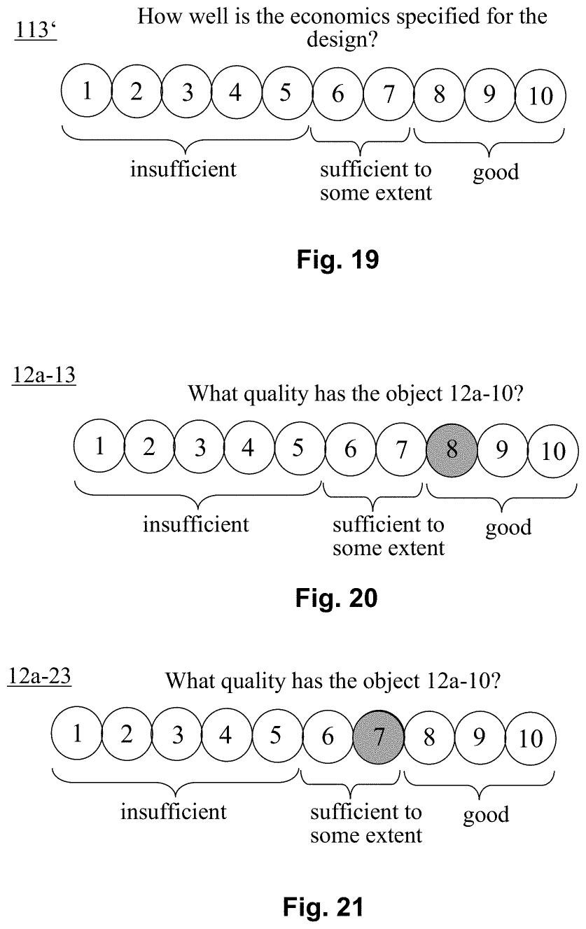

According to FIG. 19, a K-i-E-scale is used to define the economic efficiency 1124. The main question “How well is the economics specified for the design?” is to be answered. This procedure allows the participants to provide and to obtain detailed feedback for individual dimensions 1122 to 1126. The dimensions can be specifically distinguished into those that are sufficient to some extend and those who are insufficient and need to be improved. The use of a K-i-E scale should be committed with a commitment process according to U.S. Ser. No. 16/227,483 submitted with the USPTO on Dec. 20, 2018.

The single quality indicator 12a-xx enables the above described two essential characteristics, namely that the success 12a-2 reflects the quality of the precursor object 12a-10 with a successor quality indicator 12a-12 and thus controls the quality process 12a. Further, the precursor 12a-1, transfers the precursor object 12a-10 to the successor 12a-2 with an own precursor quality indicator 12a-11.

Both quality indicator 12a-11, 12a-12 are combined to a quality information being a 2-tuple, which consists of the two values of the precursor quality indicator 12a-11 and the successor quality indicator 12a-12. The successor quality indicator 12a-12 is the basis for the self-organized quality process 12a, so that an appropriate quality can be produced in subsequent process steps. The precursor quality indicator 12a-12 and the difference between the successor quality indicator 12a-12 and the precursor quality indicator 12a-11 are the basis to monitor and to control the self-learning quality process 12a.

According to FIG. 17, the quality information of the precursor object 12a-10 is evaluated by the precursor 12a-1 itself on the basis of the agreed dimensions (FIG. 3). For instance, the K-i-E scale according to FIG. 20 is used in step 12a-13. The object 12a-10 is transferred to the successor 12a-2 together with the precursor quality indicator 12a-11 of the quality information, which is value of “8” according to FIG. 20. The successor 12a-2 evaluates the quality of the object 12a-10 from its own point of view and reflects the quality information as the successor quality indicator 12a-12. For instance, the K-i-E scale according to FIG. 21 is used in step 12a-23. According to FIG. 21, the successor quality indicator 12a-12 has the value “7”.

FIG. 18 shows a block diagram of an exemplary embodiment of a quality process according to the invention that is based on the core concept as shown in FIG. 17. The above statements regarding FIG. 17 are therefore also valid for the embodiment of FIG. 18. In general, quality process 12a is a standard process to establish appropriate common quality in any process (process step). Any adaptation to the respective functional and technical details must be carried out in a change project. However, there is rarely a chance to (completely) redesign and (re-) introduce a process. In the most cases, one must accept a given situation and improve a process on that given basis. The quality process 12a is well suited for selective targeted improvements and can be integrated into existing processes. The focus of the quality process 12a is to be seen in the transition in the process chain. This transitions are referred to as quality gates I to IV.

The quality process 12a uses a quality indicator 12a-xx and requires a definition of process behavior in the quality gates I to IV between two subsequent process steps. The process has a standardized structure and any object 12a-10 (e.g. a technical requirement) starts in the precursor 12a-1, is then guided via a successor 12a-2 (e.g. a design) to an implementation entity 12a-3 and is completed with a quality management and object acceptance in quality management entity 12a-4.

Between each of these entities 12a-1 to 12a-4, one quality gate I to IV is placed. For the quality gates I to IV, the quality information is (8, 7), is derived with a K-i-E scale according to FIGS. 20 and 21. The successor 12a-2 has the expertise to assess whether the quality of the precursor object 12a-10 is sufficient to design a successor object 12a-20 with good quality on the own merits of the successor 12a-2. It is the successor's responsibility to estimate the quality based on the successor's knowledge. It is also the successor's 12a-2 duty to use the successor's experience to support the precursor 12a-1 to establish the required quality. The quality process 12a combines responsibility and knowledge of all participants together. It is not enough just to criticize. Those who have the judging-expertise are obliged to pass on exactly the necessary expertise to the precursor 12a-1 included in the quality process 12a. The precursor 12a-1 is entitled to this knowledge from the successor 12a-2 and has subsequently also the obligation to establish the quality of the precursor object 12a-10.

The successor key indicator 12a-12 of the quality information directly controls the establishment of the quality of the object 12a-10 between precursor 12a-1 and successor 12a-2. In the following, three exemplary scenarios are discussed:

Scenario 1: Assume a quality information being one of: (8, 8) or (8, 9) or (8, 10): The quality is good to excellent, and the successor 12a-2 can work on the transferred precursor object 12a-10 (that will automatically become successors object 12a-20) without any further communication. The performance of the precursor 12a-1 is expressed in the quality information in an unsolicited and appreciative manner.

Scenario 2: Assume a quality information being one of: (8, 6) or (8, 7): The quality is not yet sufficient. But the quality is good enough that a good quality can be established in a direct consultation between precursor 12a-1 and successor 12a-2. The previous performance is expressed in an appreciative way and the resource information is given to the precursor 12a-1 on its own responsibility for support. The precursor object 12a-10 is repaired under the responsibility of the precursor 12a-1 and brought up to good quality (any value between “8” to “10”) in a cooperative dialogue with the successor 12a-2.

Scenario 3: Assume a quality information being one of values (8, 1) or (8, 2) or (8, 3) or (8, 4) or (8, 5): The quality is insufficient to produce a sufficient quality for the successor object 12a-20 in the successor 12a-2 with the merits of only the successor 12a-2. Therefore, the precursor object 12a-10 is rejected. A resource process 20 according to FIGS. 29 to 33 is asked by the successor 12a-2 and appropriate resource information are provided with the rejected precursor object 12a-10. The rejected precursor object 12a-10 may then be brought to a quality of scenario 1 or 2, namely having one of the values “6”, “7”, “8”, “9” or “10”, under the responsibility of the precursor 12a-1. Such a rejection of a precursor object 12a-10 has to occur is organized and anchored in a commitment process in advance to a start of the quality process 12a. The precursor 12a-1 independently procures the necessary resources. If necessary, the successor 12a-2 shows the dimensions 1122 to 1126 to be improved using the resource information so that the quality can be established by the precursor 12a-1.

In FIG. 18 it is further shown that the control power of the successor 12a-2 (e.g. to control the quality process 12a with the quality information) also reaches the implementation entity 12a-3. So, each process owner has the responsibility to ensure the quality and to support the preceding member. That quality is controlled in a rotating manner between each process step using quality gates I to IV. So, the competence of all involved members in the quality process 12a grows and there will be mutual support for a good overall result that is activated again and again. The successor 12a-2 of the quality process 12a ensures the self-organized function of the process 12a and establishes following agile values as a result:
A) Openness in the transmission of quality information;
B) Focus on the overall result;
C) Courage to communicate an insufficient quality;
D) Eye level in responsibility and mutual support, but also in the feedback of good performances as well as for a quality that is commonly improved; and
E) Commitments that are used in a plurality of interactions throughout the entire quality process 12a.

Now using the precursor key indicator 12a-11 and the difference between the successor quality indicator 12a-12 and the precursor quality indicator 12a-11, the precursor key indicator 12a-11 shows at a glance how much effort is required to establish a sufficient quality. When using a K-i-E scale-based quality indicator, a value “8” should be the standard. In the following, five further exemplary scenarios are discussed:

Scenario 4: Assume a quality information of (8, 7). This quality information has a difference “−1”. This expresses that the reciprocal assessment differs only slightly and will be discussed further between successor 12a-2 and is learned from each other. The responsibility of the successor 12a-2 is to clearly and supportively identify (address) what is necessary to ensure the increase the quality, e.g. from a value “7” to a value “8”. The responsibility of the precursor 12a-1 is then to independently establish the quality with the resource information provided.

Scenario 5: Assume a quality information of (8, 8). This quality information has a difference “0”. This indicates an ideal state in the understanding among each other and at the same time documents an optimal ratio between effort and benefit. So, the precursor 12a-1 delivers a precursor object 12a-10 that is exactly needed to establish a successor object 12a-20 in good quality by the successor 12a-2 without additional help.

Scenario 6: Assume a quality information of (7, 7). This quality information has a difference “0”. This also indicates an ideal state in view of assessment of the quality of an object 12a-10, since both, precursor 12a-1 and successor 12a-2, assess the quality in agreement. It is to be assumed that both will cooperatively improve the quality.

Scenario 7: Assume a quality information of (8, 9). This quality information has a difference “+1”. This indicates that some of the resources currently used by the precursor 12a-1 can be saved. This is self-explanatory regulated in an open communication between precursor 12a-1 and successor 12a-2.

Scenario 8: Assume a quality information of (9, 3). This quality information has a difference of “−6”. This indicates that there is a problem that needs to be escalated. The causes can be manifold, such as misunderstandings, lack of know-how, lack of time, lack of other resource, lack of commitment. The escalation should be done by a master of the quality process 12a.

Due to the permanent feedback loop, repeatedly occurring patterns of mis-voting of quality of certain process members are levelled off after a short time.

For most processes, the default quality of a K-i-E-scale with value “8” is enough to proceed the object 12a-20 in the successor 12a-2 with a good quality. Deviations thereof result from the process peculiarities, which are reflected in the level and precision of the quality requirements express; such as:

Higher quality requirements can be controlled with a hierarchy of K-i-E scales. E.g. a production of a lens for a rangefinder requires a higher quality then the creation of a sales presentation.

Lower quality requirements allow a higher degree of freedom and leave more scope for the successors object 12a-20. In creative processes, a quality indicator 12a-xx having a value of “4” is often sufficient and desired in order to build on rough specifications and ideas that keep one's own freedom of design open.

A low quality in the standard process can be allowed to indicate that the expected quality could not be achieved because know-how, time or other resources were not available. The participants in the succession process will be warned that the agreed quality could not be achieved at the moment, but that the time targets are to be met. This gives some degrees of freedom to the self-organized teams.

FIG. 22 shows a block diagram of an exemplary embodiment of an extended quality process according to the invention based on FIG. 18. Only the differences between FIG. 22 and FIG. 18 will be described to avoid unnecessary repetitions. It should be noted that the quality gates I to IV of FIG. 18 correspond to quality gates II to V of FIG. 22. The entities 12a-1 to 12a-4 and their interconnections according to FIG. 18 remain identical in the block diagram of FIG. 22. However, the quality process 12a according to FIG. 22 is used to represent more complex processes, especially regarding a separation of different requirements. Especially in bigger companies, a strategic development and a technical development are separated and may be linked to different departments in the company. The entity 12a-1 of FIG. 22 represents a technical requirement as for instance defined by a technical development department. Further, an entity 12a-5 represents the strategic requirements as for instance defined by a strategic department. Of course, both entities 12a-1 and 12a-5 need to work together to establish a good quality on the requirement. According to FIG. 22, the technical requirement is linked to successor quality indicator 12a-52 in order to illustrate whether a rough and unspecific strategic requirement object 12a-50 has sufficient quality to be processed in subsequent processes with sufficient quality.

FIG. 23 shows a block diagram of an exemplary embodiment of an extended quality process according to the invention based on FIG. 22. Only the differences between FIG. 23 and FIG. 22 will be described to avoid unnecessary repetitions. It should be noted that the quality gates I and III to V of FIG. 22 correspond to the quality gates I and III to V in FIG. 23. The entities 12a-1 and 12a-2 to 12a-5 and their interconnections according to FIG. 22 remain identical in the block diagram of FIG. 23. However, the quality process 12a according to FIG. 23 is used to represent another complex process.

In agile projects, the quality process 12a is often the prerequisite for the successful use and introduction of agile methods. The artefacts sprint and product backlog, which receive an appropriate quality, become of high importance. Without sufficient quality, the potential of agile methods cannot be exhausted.

The agile approach as well as the classic approach shows that often in the implementation entity 12a-3, identified in quality gate III, an estimation in the successor 12a-2 in quality gate II.1 regarding effort or complexity are too high. Then either the requirement object 12a-10 has to be reconsidered or the resources need to be re-planned, using a resource process 20 according to FIGS. 29 to 33. However, in most cases, an implementation entity 12a-3 will hide such a misestimation. If resources are available, only quality issues occur. Using an inventive re-commitment object 12a-60, see quality gate II.2 in FIG. 23, having adapted requirements, such unplanned situations will be corrected and solved with the help of the requirements and the corresponding successor 12a-2.

For innovative topics or when companies venture into hardly known areas, this dynamic often occurs almost predictably. This entrepreneurial requirement is linked to the quality process 12a and provides a secure framework for the projects:

A steady state quality process 12a can be described with one single quality information for the control and monitor the transferring objects. After the implementation phase, the quality indicators 12a-11, 12a-12 for the dimensions 1122 to 1126 are omitted and, if necessary, can be reactivated and linked to clearly defined problem zones. Thus, the quality process 12a remains very simple and reacts very robust to typical difficulties that arise.

The assessment of the precursor 12a-1 as well as that of the successor 12a-2 is an expert assessment that must not be questioned. The successor 12a-2 knows what is necessary to establish an object in good quality and gives this knowledge to the precursor 12a-1. This automatically results in a learning situation that further leads to an understanding of the parties involved. This eliminates unnecessary discussions and the compulsion to justify oneself or prove oneself. The use of quality indicators 12a-xx that are chosen too low or too high will be regulated at the quality gates in a self-organized manner. It is worth noting that this self-regulating effect, regardless of the cause, has a corrective effect. Inexperience, abuse or tactical manipulation will be discovered and automatically resolved. Following situations may arise:

Situation 1: A too low rating of the precursor 12a-1 will be evaluated at eye level by the successor 12a-2 to corrected above. Over-fulfillment is expressed in an appreciative manner. The successor 12a-2 can continue to work at a high level, and the precursor 12a-1 has the choice of future with fewer resources to produce an appropriate quality.

Situation 2: A too high rating of the precursor 12a-1 is corrected by the successor 12a-2. The resource information that the successor 12a-2 must provide shows the need for improvement. The precursor 12a-1 has no arguments to enhance performance. This resource information and the commitment for the process and the dimensions take all reservations.

Situation 3: Too low rating of the successor 12a-2 would affect that resource information can be recognized. With the commitment for the process and the dimensions defined, the precursor 12a-1 establishes the cooperation on own responsibility.

Situation 4: An excessively high assessment of the successor 12a-2 would cause problems in the successor 12a-2. The overstrain in the successor object 12a-20 would be uncovered quickly in an agile approach. Benchmark information from the process can be used for all deviations and counteracted, which also has a self-regulating effect if openly communicated.

Such an inventive quality process 12a and reliable results thereof are needed everywhere. The quality process 12a can be used in any multi-stage process. The quality process 12a is suitable for innovation campaigns, ideation, strategy development, portfolio management across all implementation projects, especially with external companies such as agencies to system integrators and other partners. The quality process 12a has proven itself in classic processes consisting of requirements definition, design, implementation, quality assurance and acceptance. Excellent results were achieved with agile development methods such as Scrum and Kanban. Briefing, Recruiting and Staffing processes promise immediate return-of-investment. Especially formal processes such as those in public authorities show a high potential for improvement. The quality process 12a is universally applicable for change processes, software development processes, construction projects to be approved, BID processes, the creation of presentations, concepts and any objects with two or more process participants.

Wherever the business requirements are not implemented to the desired extent, with the required function, in a less reliable time frame, with unreasonable effort or only by means of unreasonably high communication with the participants, the quality process 12a produces the result plannable and with appropriate resources for the requirements.

The quality process 12a is a design specification for all new business processes. The quality process 12a is suitable both for selective, targeted improvements and can be integrated into existing processes. The largest benefits, so-called quick-wins, are important in the critical transitions between different to reach responsibilities, divisions and companies. Last but not least, the quality process 12a is the fundamental design specification for any human interaction, since it leads to a desired result that can be planned.

A practical consideration: Companies often have different levels of IT integration for their processes and use a variety of different IT systems. This results in essential best practices for such a quality process 12a:

A) IT systems: The simple notation in two components is excellently suited for IT integration into existing systems. A transparent documentation of the quality information in an IT system is the center success factor for the motivation of those involved in the process and for controlling, provided that is still necessary.

B) Quality Information Management: It should be managed in the area of the first process step, typically in a business requirement entity 12a-5. If it is guided deeper into the process, there is a risk of softening the quality process 12a. The delegation into an existing IT system often delays and obscures the introduction. In case of doubt, a new quality system is recommended that reunites the different IT systems.

C) Expert estimates: The K-i-E scale (according to FIG. 16) must already be introduced for the design of the change process for the expert assessment of the quality and the quality indicators 12a-xx are derived from it. The color recognition and compact representation of the quality as well as its classification on the K-i-E scale (FIG. 16) facilitate the transfer as a standard into the communication and should therefore not be changed.

In FIG. 24, a block diagram of an exemplary decision-making process including an intuition process according to the invention is shown. As already explained in FIG. 1, and also shown in FIG. 24, an external stimulus 1 is fed into a decision-making process/system. In the decision-making process, an emotional subsystem 3 and a cognitive subsystem 4 are inextricably linked. Reference 2 shows that the stimulus 1 is fed to both subsystems 3 and 4 in parallel. Both subsystems 3 and 4 are working in parallel, largely autonomously and conclude decisions at different time-points based on accesses to different memory systems. For instance, the emotional subsystem 3 may use an emotional (memory) system (not shown) in which emotional programs and/or emotional motives are stored, whereas the cognitive subsystem 4 may use a cognitive memory system (not shown). The cognitive subsystem 3 creates a coherent world view 5 (shown in dashed lines) that is based on the results of both the cognitive subsystem 3 and the emotion system 2. It cannot be said that the one subsystem 3, 4 is more powerful or better than the other one 4, 3. Both subsystems 3, 4 may lead to reasonable or faulty decisions. Both subsystems 3, 4 interact. The cognitive subsystem 4 is activated by the emotional subsystem 3. The emotional subsystem 3 operates without requests, is fast and restless. It operates in our subconsciousness. It recognizes the meaning of objects much faster than the cognitive subsystem 4 and activates it. A conscious decision 6 can be made efficiently if both subsystems 3, 4 base it on matching of facts (information) and assessing of motives. This assumption applies whenever the subsystems 3, 4 cooperate with each other and at least one of the subsystems 3, 4 has access to sufficient facts. This is ensured to a high degree by the diversity and the access to facts.

As shown in the general concept of FIG. 24, the intuition decision-making process makes use of a conscious impulse 51 that is often accompanied by a feeling, the so-called “gut feeling”. Whenever the cognitive subsystem 4 begins to create the coherent world view 5, one likes to speak of a “hunch” and when it becomes more concrete, of an “inner voice”.

The impulse 51 is generated from the action-oriented emotional subsystem 3. The emotional subsystem 3 is not accessible by the human's consciousness. The impulse 51 is usually perceived as a “GO” or “DONT-GO” impulse that can subsequently interpreted as consent or rejection. Less differentiated impulses result from an emotional excitement; or result from differently composed and differently strong emotional feelings; or lead to an extremely individual coherent world view, which consists of uncontrolled access to conscious memory content.

Inventively, it is now possible to explain these effects and at the same time it is possible to design how the intuition 52 can be used as a decision-making tool in the decision-making process of FIG. 24 in a conscious manner and how it can be used for individual, entrepreneurial and/or team-based decisions 6.

According to the inventive intuition process, it is not about “intuition” or “cognition”, it is about a sequence, namely first intuition acts, then cognition acts and finally intuition acts again. Intuition 52 has always an impact on the decision 6. Intuition 52 can now be recognized as a conscious part of a decision-making process and can be assessed accordingly. Cognition should not be excluded.

However, intuition 52 can now be recognized and integrated as a conscious component in the decision-making process/system that simulates the inextricably link between cognitive subsystem 4 and emotional subsystem 3. The cognition is (still) integrated as the central element into the sequence (intuition-cognition-intuition) of the decision-making processes.

FIG. 25 shows an exemplary decision-making system of FIG. 24 that is adapted to mainly use the intuition process as a decision-making tool according to the invention. The system components shown in FIG. 25 are the same as the system components of FIG. 24 and so, unnecessary repetitions can be avoided and only the differences between FIG. 25 and FIG. 24 are illustrated in the following.

The intuition 52 can evaluate a wide variety of stimuli 1. However, FIG. 25 solves the problem of having an inextricably link between cognitive subsystem 4 and emotional subsystem 3. According to FIG. 25, when mainly using the intuition process as a decision-making tool, the stimulus 1 according to FIG. 25 is formed and provided as a polar question 9 (also called “yes-no-question” or “general question”), whose expected answer in the intuition 52 is either “yes” (first alternative) or “no” (second alternative). Such a polar question 9 presents an exclusive disjunction, a pair of alternatives of which only one is acceptable. This requirement applies equally to whether an own intuition is to be activated or somebody else is supported or forced to use the impulse 51 to recognize. Exemplary polar questions 9 to be asked may be:
Am I sympathetic to this person?
Is the candidate technically suitable?
Do you recognize the endangerment of the project?
Is the offer well formulated?
Have we chosen the right contact person to de-escalate?
Does this formulation convince our customers?

Managers may use polar questions 9 that already aim at a commitment:
Can I rely on you?
Have I expressed myself clearly?
Are you aware that this will have consequences?
Is that your responsibility?
Can I count on your support?
Are we legally protected?

These polar questions 9 act as a clear stimulus 1 for the emotional subsystem 3. Both, the cognitive subsystem 4 and the emotional subsystem 3 are fed with that polar question 9. Inventively, the intuition 52 responds immediately with condensed expert knowledge in step 5.1 that is inaccessible to the consciousness. The response time is less than 350 milliseconds. The result in step 5.1 is either “Alternative 1” or “Alternative 2”.

The ability to perceive the impulse 51 with accompanying emotional feelings is present for most people. Leaders who have blocked natural intuition for too long or who immediately devalue natural intuition with a cognitive evaluation need a little training to reactivate their awareness.

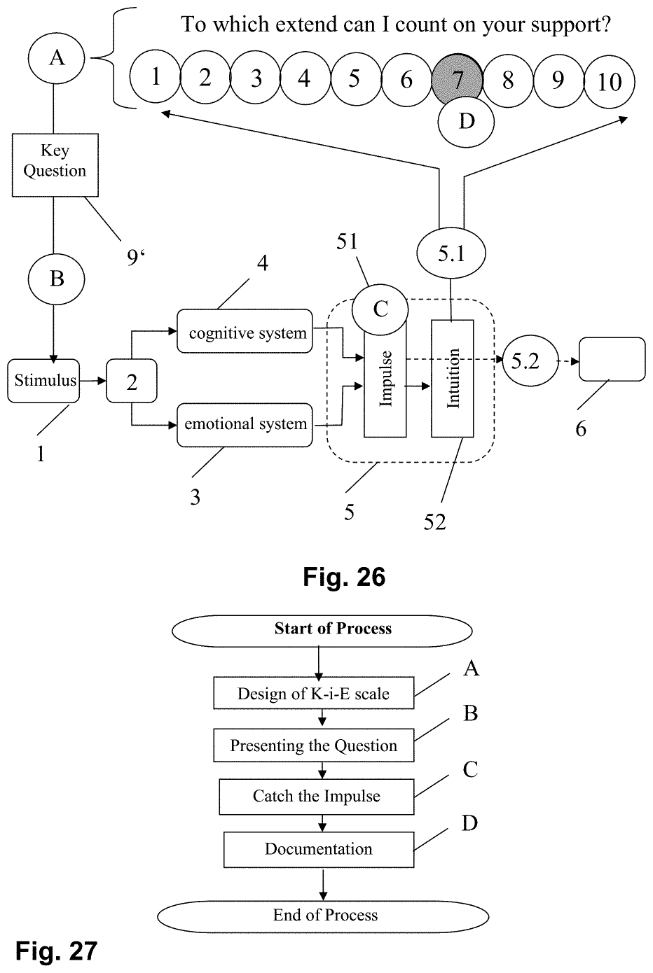

FIG. 26 shows a block diagram of an exemplary decision-making process using an intuition decision-making process according to the invention. FIG. 27 shows a flow diagram of an exemplary embodiment of an intuition process according to the invention that is based on the block diagram of FIG. 26. FIG. 26 and FIG. 27 will be described in combined fashion hereinafter. The system as shown in FIG. 26 is based on the system as shown in FIG. 25 and only the distinguishing features are discussed hereinafter.

For decisions, a simple impulse 51 (“GO”/DON'T-GO”)—see FIG. 25—from the intuition 52 may not be sufficiently differentiating. Thus, further process steps A to D are added to the inventive intuition process according to FIG. 26 and FIG. 27. The intuition as shown in FIG. 25 is further transformed into a K-i-E intuition process by using a K-i-E scale as described in FIG. 16. According to its inherent logic, the decision-making entity receives a precise and selective answer.

For the decision-making processes, the decision-making entity (=the decider)—or all those involved in the decision—an appropriate K-i-E scale is designed in step A. The general design of a K-i-E scale is already explained with above FIG. 16. This design is applicable in the inventive intuition process, too. In the intuition process, the key question 9 of the K-i-E scale is presented in step B to emphasize it as an external stimulus 1. The presenting step B increases the impulses 51 which improves the results in the intuition process. The intuition process expresses itself in different ways that are very individual. The impulses 51 are caught in step C. The catching-step C is interrupted after 350 milliseconds. The result of the intuition 52 is documented in step D.

In the following, the individual steps A to D of the intuition process of FIG. 26 and FIG. 27 are explained in greater details.

In the designing step A, a K-i-E-scale having 10 values is used. Originating from an archaic survival pattern, the K-i-E scale has a larger lower range that represents “risk avoidance” as also expressed as “concern for security”. The smaller right area in the K-i-E scale is referred to a “search for opportunities”. Specifically: the values 1 to 5 are gradations of the “no”-Alternative. Choosing such a value means that there is no support to be expected and if there is a dependency, the project likely fails. The values 6 and 7 imply a “perhaps”. In case of a resource process 20 according to FIGS. 29 to 33 one would have to clarify which circumstances would lead to support, since project success can only be achieved with additional resources. The values 8 to 10 are gradations of the “Yes”—alternative and support is guaranteed. A project's success is usually achieved without major disruptions.

According to step B, the presentation of the key question has influences on the intuition 52. The inventive intuition process reacts to key questions 9 that open an area with a question word. Following table shows some exemplary links between a natural intuition and a useful key question for the intuition process applied herein:

| Intuition process | Natural intuition with yes/no |
|---|---|
| To what extent do I like this person? | Is this person sympathetic? |
| To what extent is the candidate technically suitable? | Is the candidate technically suitable? |
| How endangered is the project? | Is the project at risk? |
| How well is the offer formulated? | Is the offer well formulated? |
| To what extent do we have the right contact person selected in order | Is this the right contact person? |
| to de-escalate? | |
| How convincing is this formulation for our customers? | Is this a convincing formulation for our customers? |
| To what extent can I rely on you? | Can I rely on you? |
| How clearly have I expressed myself? | Have I made myself clear? |
| To what extent are you aware of the consequences? | Are you aware of the consequences? |
| To what extent does this topic fall within your responsibility? | Are you responsible? |
| To what extent do you support me? | Can I count on your support? |
| To what extent are we legally protected? | Are we legally secured? |

The hidden Yes-No answering structure in the K-i-E scale ensures that the intuition 52 can always react. The middle range, e.g. values “6” and “7”, which evolutionary is referred to the cognitive subsystem 4, also has coding in the neuronal emotional programs. Emotional feelings only come into play when the emotional subsystem 3 activates the cognitive subsystem 4 and when the “head” does not correspond with the impulses 52 emitted from the “stomach”. This deviation between intuitive and cognitive evaluation shows internal conflicts and unresolved issues.

Whenever an inner dialogue has begun, the intuition is no longer acting. Even if feelings were already perceived, the cognitive subsystem 4 is already reached. Pure intuitions 52, just like natural intuitions, do not yet have feelings.

Intuition 52 has no justification. It must not have any, otherwise a coherent world view 5 would already work, which is developed in the interaction of intuition and cognition. So, the intuition 52 is recognized by a reaction time of about 350 milliseconds in step C. This time-constrain is an essential part of the intuition. All other characteristics of intuition such as effortlessness, unconscious, unsolicited or perpetual activity are also not selective enough to clearly identify the K-i-E intuition process. An impulse that appears within 350 milliseconds certainly comes from intuition 52. If it takes longer, it is no longer possible to decide whether intuition or cognition occurred, since in the decision-making system of FIG. 1, FIG. 24 to FIG. 26, it is unclear which parts work after 350 milliseconds.

So, the time duration is a clear indicator for the recognizing of intuition 52. Using the K-i-E scale, decision-makers (deciders) can now actively challenge the intuition 52 and so, intuition 52 becomes conscious.

In step A, a K-i-E scale-based question is preferably used. The ranges of the K-i-E scale take away any decision and so, an intuition 52 can react at all. The underlying emotional subsystem 3 is action-oriented and does not react in clear fashion if there is no action that does not lead to consequences. The natural intuition appears as a consciously perceptible impulse 51. The intuition 52 is between the impulse 51 from the emotional subsystem 3 and any cognition (step 5.2).

Intuition 52 can be detected reliably and selectively in a time window of 350 milliseconds after the stimulus 1 has been fed and before a cognitive decision 6 occurred in step 5.2. In following ways, the intuition 52 may be detected in step C:
People may recognize a single number or a mark on the K-i-E scale. E.g. numbers are displayed in different colors. A black-and-white or individual color coding is also possible.
People may have a clue without being able to say exactly how or where the number is represented. But they are absolutely sure.
Some people know the number without conscious inner representation.
Some people feel it through the expression of their feelings.
Some see a veil, curtain or fog behind which they see the number or perceive scale.
The spatial dimension of the scale is particularly selective. Is the scale cleanly visually presented and someone moves with one finger across the scale, most of the time fee, where the own intuition stops. Tools, such as rulers, may be used to clearly feel the impulse 51.
Few hear the numbers. The voice is very individual, and all of them come with sub-modalities such as volume, gender, language, dialect.

The learning of the intuition 52 has three central aspects:

(1) Trigger the intuition 52 with a clear focus in order to obtain the requested intuition;

(2) Perceive intuition in a selective way; and

(3) Give precise language to intuition 52, which is not accessible to the consciousness.

The first aspect (1) is taken over by the K-i-E scale itself. Its design leads from evaluation, via the meaning directly to the decision 6. If the K-i-E scale is used in a well-formed way, the intuition 52 reacts effortlessly and precisely.

The second aspect (2) is easy for managers, who usually use their emotional subsystem 3 anyway. With a bit of training, the perception of the intuition 52 within the short time period of 350 milliseconds can be learned fast and safely.

The third aspect (3) is to consciously condition one's own natural intuition 52 in order to translate the impulse 51 with the accompanying feeling into a rating number of the K-i-E scale.

In order to perceive the intuition 52 precisely, some disciplines and repeated conscious training should be used:
First discipline is to trust one's own perception. The intuition 52 is always correct because it comes from a decision-making system that cannot be influenced consciously. If it is not true, it is not the intuition 52. This is not a tautological statement and only means that it is veiled by cognition or just changed.
Second discipline is to train in constructive steps, such as blocking emerging thoughts; letting pass through thoughts that have arisen but do not influence the intuition; not letting thoughts arise in the first place.
Third discipline is a mindfulness to perceive the emotional arousal and to regulate it, if necessary. It is helpful to maintain the inner dialogue during the training to consciously observe.

Even if the intuition 52 always speaks an unambiguous language, this does not automatically mean that it leads directly to a good decision. Only an enrichment with cognitive components in a safe process makes a decision to become a good decision.

The result is largely repeatable if the factors remain stable. Since this is never completely guaranteed, the repeatability is to be seen only with restrictions:
time—it is an effective factor that cannot be reproduced identically;
the stimulus—it can be produced identically by the K-i-E scale;
the emotional excitement—it is a very fragile influencing factor, which is influenced by many factors, e.g. the intuition itself and all subsequent cognitive processes. However, emotional arousal can be regulated to a desired state by mindfulness rituals.
the emotional experience memory—it is stable and robust. However, every experience lets it learn. So, it can change in every decision-making process. Experience has shown that the change between two thought cycles is different.
the neuronal emotional programs—they are very stable, especially for experts. Even if they can be changed, it is to be assumed that within a two thoughts no great change takes place.
Influence between repetition—the indirect influence of the emotional subsystem by priming or directly by arguments and facts is given.

Repeatability of that intuitively made decisions is highly guaranteed, even if it can never be fully achieved. If a K-i-E scale is answered with intuition 52, it shows a very high agreement with a repetition. Just as clear is the deviation in the sense of a decision-making process, when real measures and facts are cited that reveal the motives of the basic emotions. The intelligent use of the intuition process thus becomes a valuable decision-making tool, which can easily make a decision at high speed and in a guaranteed time. As a reliable decision-making tool, it belongs in the repertoire of every decision maker.

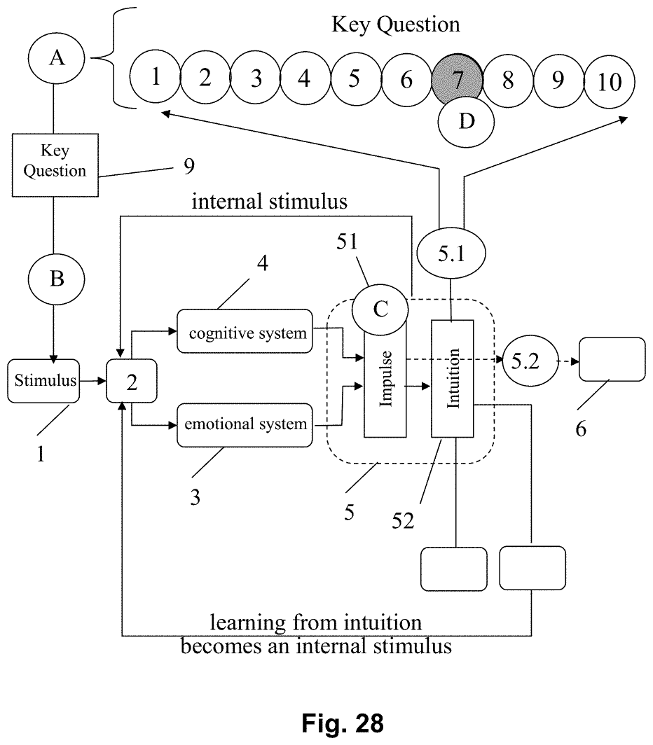

FIG. 28 shows a block diagram of an exemplary decision-making process using an intuition decision-making process according to the invention. The block diagram of FIG. 28 is based on the block diagram of FIG. 26 and in the following, only the differences between FIG. 28 and FIG. 26 will be described to avoid unnecessary repetitions. The emotional subsystem 3 always impacts but is not accessible by the conciseness. In FIG. 28 it is explained that the influence of the emotional subsystem 3 should be questioned and it should be asked whether the influence is wanted or whether it should be corrected. The emotional subsystem 3 influences the cognitive subsystem 4. An emotional excitement influences the inner cycle (FIG. 1) especially in a way of what coherent world view 5 should be built and which over-acting decision 5.2 is to be formed. The decision 6 is then the result of a plurality of cycles (see also explanations in regard to FIG. 1).

The intuition 52 is the first step to apply such a control. The intuition 52 is the first hint for identifying what the emotional subsystem 3 processed with use of the emotional logic that comprises the stimulus 1, an emotional excitement, the triggering of individual emotional programs and/or emotional motives. So, the intuition 52 is an early bird and the first possible time point to influence the decision-making process and to create it in conciseness fashion. The creation takes place by interrupting the decision-making process when obtaining the impulse 51 and to concisely recognize the intuition 52. A first and important indicator shown the intuition 52 is the strength of the impulse 51 that leads to the emotional excitement. If the emotional excitement is higher than a certain threshold, the decision-making process has to be aborted (STOP). In case of excitement lower than that threshold, mindfulness (CARE) should be shown in order to recognize the deviation between intuitive and cognitive evaluation. This deviation indicates the activatable emotional motives that already presented their effects. With an emotional tenor a further hint is obtained, which motive was triggered. These two hints (strength of impulse and emotional tenor) can now be used to make a decision in concise manner by using a feedback loop to feedback the learned intuition as an internal stimulus into the decision-making cycle.

In FIG. 29, a flow diagram of an exemplary embodiment of a resource process 20 according to the invention is shown. Here, a IS STATE is asked in step 21, then needed resources are identified in step 22, the difference between IS STATE and TARGET STATE is developed in step 23 and a goal is defined in step 24.

Following generic rules apply for the resource process 20:
Solution and problem are independent of each other.
It is advantageous when people find and discover the solution independently.
People carry all the resources within them to solve the problem.
Do not repair what is not broken.
Find out what works well and fits—and promote more of it.
If something doesn't work well enough and doesn't fit despite many efforts—then stop it and try something else.

The first basic assumption, solution and problem are independent of each other is not questioned. The processes described herein fully concentrate exclusively on the solution and how it is achieved together. A problem orientation, regardless of whether the problem has something to do with the solution or not, triggers emotional motives such as guilt, shame and fear. The natural consequence is a calibrated emotional loop, which definitely leads away from the solution and causes frictions, which will make it impossible.

In the K-i-E decision management it is assumed that people are informed about resources to achieve a common goal in step 24. Especially in companies, no individual will know or have all the things necessary for success. The resource process 20 aims to find a way to achieve the goal together in step 24. The question of resources (step 22), however, fills the difference between the current state (IS STATE) and the target state (TARGET STATE) (step 23) and at the same time determines all the necessary information as shown in FIG. 29.

The steps 21 to 24 are identified by the K-i-E scale. The inner logic of the K-i-E scale visualizes all information and documents it for all participants for further use. The K-i-E scale (as shown in FIG. 16) is consistently embedded in the resource process 20 of FIG. 29. The process 20 consistently implements the solution-oriented approach and exploits the potential of the K-i-E scale in a virtuoso manner.

In step 21, as also shown in FIG. 30, the value “7” of the K-i-E scale (=CURRENT STATE) indicates that the result is almost good enough and only little re-adjustment is necessary. This expresses the appreciation for what has been achieved until now, but it is also the assessment related to the achievement of the goals (TARGET STATE). In most situations, participants are relieved in step 21. This is because motivated employees tend to believe that their performance is not honored. Participants who assess their performance as positive or who tend to overestimate themselves, receive a good regulatory in order to reduce their need for a common working result. Governance is clearly regulated. A precursor (e.g. as defined in the quality process according to FIGS. 17 to 23) in a process chain still holds responsibility and asks the key question.

The result of step 21 of resource process 20 is clear and no further discussion is needed. So, there is no exhaustive discussion on why something is not good enough. In contrast, it is concentrated on how it can be made better. For experts, an intuition process according to FIGS. 24 to 28 provides the answer to step 21 in less than a second.

In step 22 of the resource process 20, it is asked what resource(s) is(are) required. Here, the one who has the appropriate knowledge is held responsible. A customer, a successor in multi-stage processes (such as a quality process according to FIGS. 17 to 23), a manager or a doubter obtain the knowledge about what is necessary to achieve the set goal. Governance clearly regulates that the key question is still in the responsibility of the precursor. According to the result of step 21, an exemplary key question that promotes and demands resources in step 22 could be
“What would have to be improved to move from vale “7” to value “8”?

Now the responsibility changes and so, the successor has to deliver his knowledge and know-how, so that the desired quality can be established (se quality process for further details).

Taking the “press release” example of key question according to FIG. 30, any responsible process participant would perhaps take the following measures to support:
three out of four nominalizations should be verbalized;
the author's opinion should be clearly separated from the quotation and explained;
the questionable causality should be described as a phenomenon.

It is therefore not enough to simply reject the result as insufficient.

Answering with the necessary resources immediately reveals the cooperation and seriousness of the process participant. In case, premises, specifications or frames are exceeded with the required resources, it will be recognized immediately by all involved participants and it can be counteracted accordingly. A mere doubling of budget or doubling of runtime are secure indications of a lack of cooperation. In the same way, a call for more employees is a clear indicator for any hidden topics.

A clear reference to weaknesses and deficiencies and appropriate resources to remedy them indicates cooperation. The risk of misuse of the resource process 20 to postponement of tasks or to ask for whatever resources can be prevented by change of responsibility and openness of the approaches. Unfair attempts are healed by the resource process 20 through the inner logic. In any other case, the problem or the causing entity becomes visible.

It may help to secure the step 22 with a K-i-E scale question according to FIG. 31. This will avoid any “moving targets” and open loops. At the same time the process 20 gets security, and the rework gets a clear goal. The key question could be adapted to the current situation, the diction in the company and the business process, such as:
What would have to be done to get you from value “6” to value “8?
What action should be taken to move from value “6” to value “8”?
What is necessary to . . . ?
What would have to happen to . . . ?

The K-i-E scale in step 22 not only secures the process 20, but also signals what is necessary it achieve a very good result. Again, the above described intuition process may be used to increase speed.

In step 23, current state and target state are compared, and the difference is identified. The K-i-E scale reveals at a glance, especially through the distance and the color coding, how far it is to the goal to be achieved. Through the inner logic of the K-i-E scale, all participants receive a standardized, accepted and precise view of the situation, which is illustrated by the distance and the color coding.

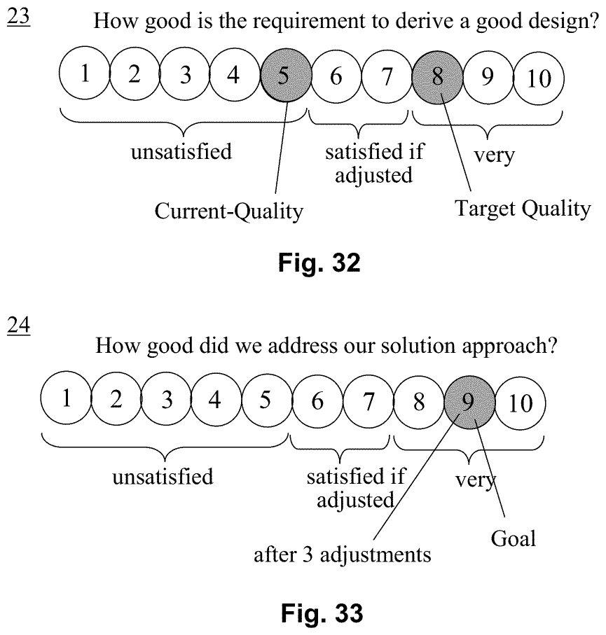

In FIG. 32, an exemplary K-i-E scale is shown as used for step 23 of the resource process 20. The distance on the K-i-E scale naturally depends on the parties involved and their individual ability to estimate a quality critically or benevolently. The distance, however, will be reduced in the respective business process, and guideline values will be established. The clear location immediately shows the distance to the achievement of the goal. The K-i-E scale gets the character of a process information, in the sense of “what to do” and “how much to do”.

The distance between the values in the K-i-E scale can be interpreted as follows:
Distance=1: The goal can be reached with little effort.
Distance=2: This indicates a feasible effort with which the target state can be achieved.
Distance=3: This means further measures to be planned. In a classic project design, this means that the project must be stopped.
Distance=4: The goal is clearly at risk and can only be reached in exceptional cases and with high attentiveness in the planning of measures.
Distance>=5: The goal can normally no longer be achieved.

This practical experience comes from around 300 projects in various fields. Business processes such as preparation of offers, presentations, design, planning, briefing, acceptance and much more.

Step 24 of the process 20 identifies the question about the goal(s) to be achieved. FIG. 33 shows an exemplary key question to be asked in step 24. Experience in dealing with the K-i-E scale can also be cognitively retrieved from this knowledge. The cost-benefit-ratio is optimal for a value of “8”. Even if a higher quality is used in the individual case, this quality is not reached at first attempt in most enterprises and with nearly all projects. It must first be produced with a quality process as described above with FIGS. 17 to 23.

In the case of very well-trained managers or coaches, the question occasionally arises as to why the target value to be achieved is the value “8”. This is particularly true in certain industries, which always or gladly strive for the best quality and optimum. The K-i-E scale represents intuition and is also suitable for querying a cognitive answer. The emotional motives that strive to achieve the goal are mapped in the neurological emotional programs. They provide equally for individuality such as diversity and for a high degree of agreement in the assessment of the target fulfillment.

Irrespective of these universally valid principles of action, certain projects or higher quality business processes that can be effortlessly implemented in the K-i-E scale. A sales team, for instance, will be able to present an important offer to a customer with a target (=goal) well to get his chance to win a contract.

Cooperation and mutual assistance are provided through the resource process 20 as developed here. This cyclical evolutionary effect gives companies the chance to exploit their potentials and to develop them further at the same time. The resource process 20 and its answer in the K-i-E scale leads all those involved into a process that automatically makes:
Openness—immediately visible documentation and standardized meaning;
Focus—solidly anchored in the complete process of the resource process;
Courage—the inner logic allows and demands constructive feedback;
Eye level—leads to appreciation and automatic support;
Commitment—the process is transparent.

When using the K-i-E resource process 20, adherence to the process is made. The answer will show both quality and cooperation. The responsibility for the content remains where governance provides for it. The K-i-E resource process is not a tool to delegate responsibility.

The used term “commitment” on which the above-described prioritization process and the above described quality process 12a are based herein is inventively meant as follows: People, especially experts, may give their commitment if they themselves are convinced of the success and the sustainability of an enterprise. The measures necessary for a success may now be integrated in the inventive commitment step as part of the prioritization process and the quality process 12a. It can increase the self-perceived identification and commitment to use one's own abilities to attain a goal. The identification and loyalty to that goal is the essential success factor par excellence. The effort for control and control can decrease significantly and can lead the communication with each individual participant into a new dimension. The speed of decisions significantly increases. Now, an employee motivation is not a consistent result of successful decisions and their implementation and a first central building block for self-organization and ownership. Reservations, risks and hidden conflicts that cause increases and delays in subsequent stages of the project—e.g. after significant investments have already been made—can be identified in very early stages and counteracted before the project even starts. The measures to ensure success are worked out together and thus are jointly supported on, so, each participant agrees on the decided measures. The effect in the subsequent implementation is central to the success. All participants are involved with their commitment, and the inventive process forces everyone to speak out and take a viewable stance. Divergent perspectives are visible right from the beginning and, through the participation and participation of all, they lead to a common constructive solution.

The prioritization process can be integrated into a computer system. The computer system may comprise system components that simulate the participants. These components may have at least a first motive profile for providing participant dependent intermediate decisions under motivational profile-dependent evaluation of the decision to be decided.

Commitment in the prioritization process and the quality process 12a basically means the ability of self-perceived obligation to bring one's own abilities in, to attain a goal.

A commonly shared (jointly forced) decision includes the decision and its implementation, which also needs to be commonly supported. Identification and loyalty to the common objectives are the essential success factor par excellence. They significantly reduce the effort for control and monitoring and are a first central building block for self-organization, ownership and automation. People, employees and, experts only give a commitment during a prioritization if they themselves are convinced of the success and sustainability of the enterprise. The measures necessary for success are now integrated into the prioritization process. Reservations, risks and hidden conflicts are identified at an early stage, which reduces costs and reduces delays. The achieved positive effect in such an implementation is a central aspect to the success. The term “jointly supported” herein reflects that the decision has been commonly agreed upon by each participant, which means that the decision has been made in common with each participant and additionally that this decision is borne by each participant. So, it becomes a liable and supported decision, too.

The goal of jointly supported decisions is achieved in a clear process. Reservations/objectives, risks and hidden conflicts become transparent at an early stage, causing later increases in costs and expenses, and delays if significant investments have already been made.

The commitment process is considered as a superior decision-making tool for a new integrated leadership style and as the legitimate successor to the post-heroic or post-modern leadership style. It replaces all participatory approaches with genuine shared participation in a jointly supported decision 107.

In corporate governance, the commitment process can preserve the traditional hierarchical organization while at the same time engaging all stakeholders in a jointly supported decision. All agile or classic projects are suitable. The gap due to the lack of operationalization in SCRUM and other agile methods is effectively closed by the commitment process. No relevant step should be taken without the commitment process: starting with vision, goal, project approach, technology selection, staffing, kick-off or sprint planning, and ending with acceptance or sprint review, retrospective and other ceremonies. The newly created leadership situation between traditional areas and agile teams can be bridged with the commitment process. In particular, the product owner is not without an interface between the department and the agile teams.

The commitment process shows its greatest benefit in standardized rule meetings, but its effect is very demonstrative for individual just critical decision-making needs, especially under the moderation of a Master in the commitment process, for instance useful in multi-stage standard processes. This ensures secure commitments such as delivery results in the briefing process, team decisions, acceptance of delivery results and partial deliveries in studies and projects. For the acceptance of all goal definitions, the commitment process is a prerequisite.

A sovereign handling of the K-i-E scale is to be assumed. The need for a decision must have a quality that can be produced with the quality process as described in FIG. 17 to FIG. 23. Other K-i-E tools, such as the prioritization process or the motivational triangle, are indispensable tools for modifying occurring problems and unforeseeable tasks. These processes are not discussed herein but should be considered when applying the commitment process.

In any case, it must be ensured that an evaluation can and must take place without any influence. The implementation requires solid leadership skills. They primarily require experience in the management and organization of meetings and moderation. In addition to a secure appearance, process and content-based understanding of the decision-making requirements for acceptance in the group are advised.

All features of all embodiments described, shown and/or claimed herein can be combined with each.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a feature of the invention may have been disclosed with respect to only one of several implementations, such feature may be combined with one or more other features of the other implementations as may be desired and advantageous for any given or particular application.

What is claimed is:

1. A prioritization process for achieving a commonly agreed ranking of a plurality of topics handleable with resources available by a plurality of participants, the process comprises the following steps:
Deciding, by each participant, whether a common understanding of a specific topic exists;
Evaluating, by each participant, that specific topic using only one priority indicator represented by a scale of ten different values;
Committing, by each participant, on a commonly shared prioritization, expressed by a committed priority indicator of that specific topic; and
Ranking of the plurality of topics based on the committed commonly shared prioritization of each specific topic.

2. The prioritization process according to claim 1, wherein if in the deciding-step it is determined that common understanding of that specific topic is not achieved, the specific topic is excluded from the prioritization process or the specific participant is excluded from the prioritization of that topic.

3. The prioritization process according to claim 1, wherein if in the deciding step it is determined that common understanding of that specific topic is not yet achieved but is achievable, directly establishing the common understanding of that specific topic by starting a clarification process including a predefined number of questions preferably followed by a final commitment step to identify whether a common understanding exists.

4. The prioritization process according to claim 1, wherein the deciding step is processed by using another priority indicator represented by a scale of ten different values.

5. The prioritization process according to claim 1, wherein the evaluating step comprises a first evaluation and a second evaluation, wherein between the first evaluation and the second evaluation, only participants who decided uppermost and lowest values of the priority indicator elucidate their decision by providing further details.

6. The prioritization process according to claim 5, wherein the first evaluation is made by all participants and the results of the first evaluation are concealed until all participants completed the first evaluation.

7. The prioritization process according to claim 1, wherein the committing step comprises a first committing step in which it is decided whether all participants commit to a commonly shared prioritization of that specific topic or not.

8. The prioritization process according to claim 7, wherein in case in the committing step it is determined that at least one participant does not commit a commonly shared prioritization of that specific topic, the prioritization process for the specific topic is dealt in alternative manner.

9. The prioritization process according to claim 7, wherein the committing step is processed by using one priority indicator represented by a scale of ten different values.

10. The prioritization process according to claim 8, wherein the committing step is processed by using one priority indicator represented by a scale of ten different values.

11. The prioritization process according to claim 1, wherein the committing step provides a pre-ranking of topics in a maximum of six groups, wherein only the topics in the first five of the six groups of topics are ranked.

12. The prioritization process according to claim 1, wherein the committing step provides a group of topics that is not ranked in that prioritization process.

13. The prioritization process according to claim 1, wherein in the ranking step it is determined whether an agile method or a conventional method for further topic processing is applied.

14. The prioritization process according to claim 13, wherein the committing step provides a pre-ranking of topics in a maximum of six groups, wherein only the topics in five of the six groups of topics are prioritized and when an agile method is applied, the five groups are directly shifted to a backlog of the agile method.

15. The prioritization process according to claim 13, wherein the committing step provides a pre-ranking of topics in a maximum of six groups, wherein only the topics in five of the six groups of topics are prioritized and when a conventional method is applied, the topics in each of the five groups are weighted with Fibonacci numbers dependent on the number of participants in the prioritization process and dependent on the number of topics in each group.

16. The prioritization process according to claim 1, wherein prior to the deciding step, design parameters for the prioritization process are defined, wherein a first parameter is a number of questions allowed in the deciding steps and wherein a second parameter is a number of question allowed in the committing process.

17. The prioritization process according to claim 1, wherein the prioritization indicator evaluates the specific topic according to urgency, importance, knowledge, degree on similarity, degree on difference and/or time.

18. A prioritization software application for leading the prioritization-process of claim 1 by designing and generating questions, collecting and protocolling each answer from each participant of the prioritization process and protocolling the answers as a cloud-based service.
